(19) United States
(12) Patent Application Publication
(10) Pub. No.: US 2026/0181061 A1
(43) Pub. Date: Jun. 25, 2026

(54) METHOD AND APPARATUS FOR SESSION MANAGEMENT

(71) Applicant: Telefonaktiebolaget LM Ericsson (publ), Stockholm (SE)

(72) Inventors: Wen ZHANG, Shanghai (CN); Juying GAN, Shanghai (CN); Yunjie LU, Shanghai (CN); Jinyin ZHU, Shanghai (CN)

(21) Appl. No.: 19/125,650

(22) PCT Filed: Oct. 30, 2023
(86) PCT No.: PCT/CN2023/127675

§ 371 Date: Apr. 29, 2025

(30) Foreign Application Priority Data
Oct. 31, 2022 (WO) PCT/CN2022/128645

(51) Int. Cl. H04L 69/322; H04L 47/24; H04L 65/1069

(52) U.S. Cl. CPC H04L 69/322; H04L 47/24; H04L 65/1069

(57) ABSTRACT

Embodiments of the present disclosure provide method and apparatus for session management. A method performed by a first session management function (SMF) comprises marking that a status of at least one quality of service (QoS) flow is to be synchronized with a terminal device. The at least one QoS flow is managed by the first SMF and a second SMF.

### TECHNICAL FIELD

The non-limiting and exemplary embodiments of the present disclosure generally relate to the technical field of communications, and specifically to methods and apparatuses for session management.

### BACKGROUND

This section introduces aspects that may facilitate a better understanding of the disclosure. Accordingly, the statements of this section are to be read in this light and are not to be understood as admissions about what is in the prior art or what is not in the prior art.

In some networks, there may be various sessions such as protocol data unit (PDU) sessions. For example, a user equipment (UE) may initiate a PDU session establishment procedure. A UE may initiate PDU session handover between 3GPP (Third Generation Partnership Project) network and non-3GPP network. A UE may initiate PDU session handover from Evolved Packet System (EPS) to fifth generation system (5GS). A network may trigger a PDU session establishment procedure.

PDU session modification procedure may be used when one or several of the quality of service (QoS) parameters exchanged between the UE and the network are modified.

The conditions when to use the PDU session modification procedure for QoS change as well as the QoS parameters exchanged between the UE and the network are defined in clause 5.7 of 3GPP TS 23.501 V17.5.0, the disclosure of which is incorporated by reference herein in its entirety.

FIG. 1a shows a flowchart of UE or network requested PDU Session Modification (for non-roaming and roaming with local breakout), which is same as FIG. 4.3.3.2-1 of 3GPP TS 23.502 V17.5.0, the disclosure of which is incorporated by reference herein in its entirety.

For non-roaming and roaming with local breakout, if the N1 PDU Session Modification Command message to delete QoS Flow(s) cannot reach the UE due to no paging response, the SMF will mark the QoS Flows to be removed and later at next UP (user plane) activation the SMF performs PDU Session Modification procedure to remove the QoS Flow(s).

The following description of steps 1d and 11 is a copy of steps 1d and 11 in clause 4.3.3.2 of 3GPP TS 23.502 V17.5.0.

At step 1d. (SMF requested modification) The session management function (SMF) may decide to modify PDU Session. This procedure also may be triggered based on locally configured policy or triggered from the (R)AN (radio access network) (see clause 4.2.6 and clause 4.9.1 of 3GPP TS 23.502 V17.5.0). It may also be triggered if the UP connection is activated (as described in Service Request procedure) and the SMF has marked that the status of one or more QoS (quality of service) Flows are deleted in the 5GC (fifth generation core network) but not synchronized with the UE yet.

At step 11. The AMF (Access and Mobility Management Function) forwards the N1 SM (session management) container (PDU Session Modification Command Ack) and User Location Information received from the AN (access network) to the SMF via Nsmf_PDUSession_UpdateSMContext service operation. The SMF replies with a Nsmf_PDUSession_UpdateSMContext Response.

If the SMF initiated modification is to delete QoS Flows (e.g. triggered by PCF (policy control function)) which do not include QoS Flow associated with the default QoS rule and the SMF does not receive response from the UE, the SMF marks that the status of those QoS Flows is to be synchronized with the UE.

The other steps of FIG. 1a are described in clause 4.3.3.2 of 3GPP TS 23.502 V17.5.0, the description of these steps is omitted here for brevity.

FIG. 1b shows a flowchart of UE or network requested PDU Session Modification (home-routed roaming), which is same as FIG. 4.3.3.3-1 of 3GPP TS 23.502 V17.5.0, the disclosure of which is incorporated by reference herein in its entirety.

The following description of steps 1d and 14-15 is a copy of steps 1d and 11 in clause 4.3.3.2 of 3GPP TS 23.502 V17.5.0.

At step 1d. (HPLMN requested) This step is the same as step 1d of FIG. 1a.

At steps 13-14. These steps are the same as step 11a-11b of FIG. 1a but executed in Visited PLMN (Public Land Mobile Network).

At step 15. V-SMF responds to the H-SMF with an Nsmf_PDUSession_Update response carrying the information like Protocol Configuration Options (PCO) provided by the UE in the SM PDU Session Modification Command Ack message from the UE to the V-SMF, Secondary RAT (Radio Access Technology) usage data. The H-SMF shall modify the PDU Session context.

If the V-SMF has rejected QFI(s) (step3) or the (R)AN has rejected QFI(s) in step 6 of FIG. 1a, the H-SMF is responsible of later updating the QoS rules and QoS Flow level QoS parameters if needed for the QoS Flow(s) associated with the QoS rule(s) in the UE.

The other steps of FIG. 1b are described in clause 4.3.3.3 of 3GPP TS 23.502 V17.5.0, the description of these steps is omitted here for brevity.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

According to FIGS. 1a-1b, step 1d of FIG. 1b refers to the same step of FIG. 1a, i.e., the H-SMF is expected to perform PDU Session Modification to delete QoS Flow(s) whose status is to be synchronized with the UE. However, it is not clear how the H-SMF knows when to perform step 1d. To address this issue, there can be two options.

Option-1: V-SMF informs H-SMF of the UP activation.

Option-2: V-SMF informs H-SMF of the QoS Flow(s) whose status is to be synchronized with the UE when the UP connection is activated.

Steps 13-14 of FIG. 1b refer to step 11a-11b of FIG. 1a, and it is not clear whether the V-SMF and H-SMF should mark that status of those QoS Flows is to be synchronized with the UE.

It is not defined for I-SMF (intermediate SMF or I_SMF)/V-SMF (visited SMF or V_SMF) how to handle when the H-SMF (home SMF or H_SMF)/A-SMF (anchor-SMF) triggers QoS flow modification (such as QoS flow deletion) and the UE is not reachable. It is also not defined for I-SMF/V-SMF how to handle when QoS flow is needed to be modified (such as released) during AN release with I-SMF/V-SMF and UE is not reachable. In these scenarios, the PDU session modification procedure may be failed. Function of synchronizing QoS Flow(s) status between UE and 5GC does not work with V/I-SMF involved.

To overcome or mitigate at least one of above mentioned problems or other problems, the embodiments of the present disclosure propose an improved solution for session management.

In an embodiment, when PDU Session Modification Command message for QoS Flow deletion cannot reach the UE (e.g. due to no paging response), both V-SMF/I-SMF and H-SMF/A-SMF mark the status of one or more QoS Flows are deleted in the 5GC but not synchronized with the UE yet. At the next UP activation, if V-SMF/I-SMF has marked that the status of one or more QoS Flows are deleted in the 5GC but not synchronized with the UE yet, the V-SMF/I-SMF sends indication to H-SMF/A-SMF to synchronize the QoS Flow(s) status with the UE.

In a first aspect of the disclosure, there is provided a method performed by a first session management function (SMF). The method comprises marking that a status of at least one quality of service (QoS) flow is to be synchronized with a terminal device. The at least one QoS flow is managed by the first SMF and a second SMF.

In an embodiment, the at least one QoS flow is not associated with a default QoS rule.

In an embodiment, the status of at least one QoS flow comprises a deletion of at least one QoS flow.

In an embodiment, the method further comprises during a first SMF insert procedure, obtaining, from the second SMF, information that the status of the at least one QoS flow is to be synchronized with the terminal device and/or information used for the first SMF to send an N1 message to the terminal device to synchronize the status of the at least one QoS flow with the terminal device.

In an embodiment, the method further comprises during a first SMF change procedure, obtaining, from an old first SMF, information that the status of the at least one QoS flow is to be synchronized with the terminal device and/or information used for the first SMF to send an N1 message to the terminal device to synchronize the status of the at least one QoS flow with the terminal device.

In an embodiment, the method further comprises during a first SMF change procedure, sending, to a new first SMF, information that the status of the at least one QoS flow is to be synchronized with the terminal device and/or information used for the new SMF to send an N1 message to the terminal device to synchronize the status of the at least one QoS flow with the terminal device.

In an embodiment, the method further comprises receiving a protocol data unit (PDU) session update request comprising a PDU session modification command for the at least one QoS flow from the second SMF. The method further comprises determining that the terminal device is not reachable. The method further comprises sending a PDU session update response comprising information that the status of the at least one QoS flow is to be synchronized with the terminal device or is not synchronized with the terminal device to the second SMF.

In an embodiment, the method further comprises determining a PDU session modification command for the at least one QoS flow. The method further comprises determining that the terminal device is not reachable. The method further comprises sending a PDU session update request comprising information that the status of the at least one QoS flow is to be synchronized with the terminal device or is not synchronized with the terminal device to the second SMF.

In an embodiment, the at least one QoS flow comprises at least one guaranteed bit rate (GBR) QoS flow.

In an embodiment, the PDU session modification command for the at least one QoS flow is determined during an access network release procedure.

In an embodiment, the method further comprises receiving, from the second SMF, a PDU session update request comprising a PDU session modification command for the at least one QoS flow and information used for the first SMF to send an N1 message to the terminal device to synchronize the status of the at least one QoS flow with the terminal device. The method further comprises determining that the terminal device is not reachable. The method further comprises sending information that the terminal device is not reachable to the second SMF. The method further comprises performing the PDU session modification command for the at least one QoS flow. The method further comprises when the terminal device is reachable, complying the N1 message based on the information used for the first SMF to send an N1 message to the terminal device to synchronize the status of the at least one QoS flow with the terminal device. The method further comprises sending the N1 message to the terminal device. The method further comprises sending information that the status of the at least one QoS flow has been synchronized with the terminal device to the second SMF.

In an embodiment, the PDU session modification command comprises a deletion of the at least one QoS flow.

In an embodiment, the method further comprises determining that the terminal device is reachable. The method further comprises when there is a mark that the status of the at least one QoS flow is to be synchronized with the terminal device, sending a PDU session update request comprising information indicating the second SMF to synchronize the status of the at least one QoS flow with the terminal device to the second SMF.

In an embodiment, the method further comprises when the status of the at least one QoS flow has been synchronized with the terminal device, deleting a mark that the status of the at least one QoS flow is to be synchronized with the terminal device.

In an embodiment, the first SMF comprises at least one of an intermediate SMF, or a visited SMF.

In an embodiment, the second SMF comprises at least one of an SMF, or a home SMF.

In a second aspect of the disclosure, there is provided a method performed by a second SMF. The method comprises marking that a status of at least one quality of service (QoS) flow is to be synchronized with a terminal device. The at least one QoS flow is managed by a first SMF and the second SMF.

In an embodiment, the at least one QoS flow is not associated with a default QoS rule.

In an embodiment, the status of at least one QoS flow comprises a deletion of at least one QoS flow.

In an embodiment, the method further comprises during a first SMF insert procedure, sending, to the first SMF, information that the status of the at least one QoS flow is to be synchronized with the terminal device and/or information used for the first SMF to send an N1 message to the terminal device to synchronize the status of the at least one QoS flow with the terminal device.

In an embodiment, the method further comprises sending a protocol data unit (PDU) session update request comprising a PDU session modification command for the at least one QoS flow to the first SMF. The method further comprises receiving a PDU session update response comprising information that the status of the at least one QoS flow is to be synchronized with the terminal device or is not synchronized with the terminal device from the first SMF.

In an embodiment, the method further comprises receiving a PDU session update request comprising information indicating the second SMF to synchronize the status of the at least one QoS flow with the terminal device from the first SMF. The method further comprises sending a PDU session update request comprising a PDU session modification command for the at least one QoS flow to the first SMF.

In an embodiment, the method further sending, to the first SMF, a PDU session update request comprising a PDU session modification command for the at least one QoS flow and information used for the first SMF to send an N1 message to the terminal device to synchronize the status of the at least one QoS flow with the terminal device. The method further comprises receiving information that the terminal device is not reachable from the first SMF. The method further comprises performing the PDU session modification command for the at least one QoS flow. The method further comprises when the terminal device is reachable, receiving information that the status of the at least one QoS flow has been synchronized with the terminal device to the second SMF.

In an embodiment, the method further comprises sending an event exposure subscribe request for a reachability event of the terminal device to an access and mobility management function (AMF). The method further comprises receiving the reachability event of the terminal device from the AMF. The method further comprises when there is a mark that the status of the at least one QoS flow is to be synchronized with the terminal device, sending a PDU session update request comprising a PDU session modification command for the at least one QoS flow to the first SMF.

In an embodiment, the PDU session modification command comprises a deletion of the at least one QoS flow.

In an embodiment, the method further comprises when the status of the at least one QoS flow has been synchronized with the terminal device, deleting a mark that the status of the at least one QoS flow is to be synchronized with the terminal device.

In an embodiment, the method further comprises receiving a PDU session update request comprising information that the status of the at least one QoS flow is to be synchronized with the terminal device or is not synchronized with the terminal device from the first SMF.

In an embodiment, the at least one QoS flow comprises at least one guaranteed bit rate (GBR) QoS flow.

In an embodiment, the first SMF comprises at least one of an intermediate SMF, or a visited SMF.

In an embodiment, the second SMF comprises at least one of an SMF, or a home SMF.

In a third aspect of the disclosure, there is provided a first SMF. The first SMF comprises a processor and a memory coupled to the processor. Said memory contains instructions executable by said processor. Said first SMF is operative to mark that a status of at least one quality of service (QoS) flow is to be synchronized with a terminal device. The at least one QoS flow is managed by the first SMF and a second SMF.

In a fourth aspect of the disclosure, there is provided a second SMF. The second SMF comprises a processor and a memory coupled to the processor. Said memory contains instructions executable by said processor. Said second SMF is operative to mark that a status of at least one quality of service (QoS) flow is to be synchronized with a terminal device. The at least one QoS flow is managed by a first SMF and the second SMF.

In a fifth aspect of the disclosure, there is provided a first SMF. The first SMF comprises a marking module configured to mark that a status of at least one quality of service (QoS) flow is to be synchronized with a terminal device. The at least one QoS flow is managed by the first SMF and a second SMF.

In an embodiment, the first SMF further comprises a first obtaining module configured to, during a first SMF insert procedure, obtain, from the second SMF, information that the status of the at least one QoS flow is to be synchronized with the terminal device and/or information used for the first SMF to send an N1 message to the terminal device to synchronize the status of the at least one QoS flow with the terminal device.

In an embodiment, the first SMF further comprises a second obtaining module configured to, during a first SMF change procedure, obtain, from an old first SMF, information that the status of the at least one QoS flow is to be synchronized with the terminal device and/or information used for the first SMF to send an N1 message to the terminal device to synchronize the status of the at least one QoS flow with the terminal device.

In an embodiment, the first SMF further comprises a first sending module configured to, during a first SMF change procedure, send, to a new first SMF, information that the status of the at least one QoS flow is to be synchronized with the terminal device and/or information used for the new SMF to send an N1 message to the terminal device to synchronize the status of the at least one QoS flow with the terminal device.

In an embodiment, the first SMF further comprises a first receiving module configured to receive a protocol data unit (PDU) session update request comprising a PDU session modification command for the at least one QoS flow from the second SMF.

In an embodiment, the first SMF further comprises a first determining module configured to determine that the terminal device is not reachable.

In an embodiment, the first SMF further comprises a second sending module configured to send a PDU session update response comprising information that the status of the at least one QoS flow is to be synchronized with the terminal device or is not synchronized with the terminal device to the second SMF.

In an embodiment, the first SMF further comprises a second determining module configured to determine a PDU session modification command for the at least one QoS flow.

In an embodiment, the first SMF further comprises a third determining module configured to determine that the terminal device is not reachable.

In an embodiment, the first SMF further comprises a third sending module configured to send a PDU session update request comprising information that the status of the at least one QoS flow is to be synchronized with the terminal device or is not synchronized with the terminal device to the second SMF.

In an embodiment, the first SMF further comprises a second receiving module configured to receive, from the second SMF, a PDU session update request comprising a PDU session modification command for the at least one QoS flow and information used for the first SMF to send an N1 message to the terminal device to synchronize the status of the at least one QoS flow with the terminal device.

In an embodiment, the first SMF further comprises a fourth determining module configured to determine that the terminal device is not reachable.

In an embodiment, the first SMF further comprises a fourth sending module configured to send information that the terminal device is not reachable to the second SMF.

In an embodiment, the first SMF further comprises a performing module configured to perform the PDU session modification command for the at least one QoS flow.

In an embodiment, the first SMF further comprises a complying module configured to, when the terminal device is reachable, comply the N1 message based on the information used for the first SMF to send an N1 message to the terminal device to synchronize the status of the at least one QoS flow with the terminal device.

In an embodiment, the first SMF further comprises a fifth sending module configured to send the N1 message to the terminal device.

In an embodiment, the first SMF further comprises a sixth sending module configured to send information that the status of the at least one QoS flow has been synchronized with the terminal device to the second SMF.

In an embodiment, the first SMF further comprises a fifth determining module configured to determine that the terminal device is reachable.

In an embodiment, the first SMF further comprises a seventh sending module configured to, when there is a mark that the status of the at least one QoS flow is to be synchronized with the terminal device, send a PDU session update request comprising information indicating the second SMF to synchronize the status of the at least one QoS flow with the terminal device to the second SMF.

In an embodiment, the first SMF further comprises a deleting module configured to, when the status of the at least one QoS flow has been synchronized with the terminal device, delete a mark that the status of the at least one QoS flow is to be synchronized with the terminal device.

In a sixth aspect of the disclosure, there is provided a second SMF. The second SMF comprises a marking module configured to mark that a status of at least one quality of service (QoS) flow is to be synchronized with a terminal device. The at least one QoS flow is managed by a first SMF and the second SMF.

In an embodiment, the second SMF further comprises a first sending module configured to, during a first SMF insert procedure, send, to the first SMF, information that the status of the at least one QoS flow is to be synchronized with the terminal device and/or information used for the first SMF to send an N1 message to the terminal device to synchronize the status of the at least one QoS flow with the terminal device.

In an embodiment, the second SMF further comprises a second sending module configured to send a protocol data unit (PDU) session update request comprising a PDU session modification command for the at least one QoS flow to the first SMF.

In an embodiment, the second SMF further comprises a first receiving module configured to receive a PDU session update response comprising information that the status of the at least one QoS flow is to be synchronized with the terminal device or is not synchronized with the terminal device from the first SMF.

In an embodiment, the second SMF further comprises a second receiving module configured to receive a PDU session update request comprising information indicating the second SMF to synchronize the status of the at least one QoS flow with the terminal device from the first SMF.

In an embodiment, the second SMF further comprises a second sending module configured to send a PDU session update request comprising a PDU session modification command for the at least one QoS flow to the first SMF.

In an embodiment, the second SMF further comprises a third sending module configured to send, to the first SMF, a PDU session update request comprising a PDU session modification command for the at least one QoS flow and information used for the first SMF to send an N1 message to the terminal device to synchronize the status of the at least one QoS flow with the terminal device.

In an embodiment, the second SMF further comprises a third receiving module configured to receive information that the terminal device is not reachable from the first SMF.

In an embodiment, the second SMF further comprises a performing module configured to perform the PDU session modification command for the at least one QoS flow.

In an embodiment, the second SMF further comprises a fourth receiving module configured to, when the terminal device is reachable, receive information that the status of the at least one QoS flow has been synchronized with the terminal device to the second SMF.

In an embodiment, the second SMF further comprises a fourth sending module configured to send an event exposure subscribe request for a reachability event of the terminal device to an access and mobility management function (AMF).

In an embodiment, the second SMF further comprises a fifth receiving module configured to receive the reachability event of the terminal device from the AMF.

In an embodiment, the second SMF further comprises a fifth sending module configured to, when there is a mark that the status of the at least one QoS flow is to be synchronized with the terminal device, send a PDU session update request comprising a PDU session modification command for the at least one QoS flow to the first SMF.

In an embodiment, the second SMF further comprises a deleting module configured to, when the status of the at least one QoS flow has been synchronized with the terminal device, delete a mark that the status of the at least one QoS flow is to be synchronized with the terminal device.

In an embodiment, the second SMF further comprises a sixth receiving module configured to receive a PDU session update request comprising information that the status of the at least one QoS flow is to be synchronized with the terminal device or is not synchronized with the terminal device from the first SMF.

In another aspect of the disclosure, there is provided a computer program product comprising instructions which when executed by at least one processor, cause the at least one processor to perform the method according to any one of the first or second aspect.

In another aspect of the disclosure, there is provided a computer-readable storage medium storing instructions which when executed by at least one processor, cause the at least one processor to perform the method according to any one of the first or second aspect.

Embodiments herein may provide many advantages, of which a non-exhaustive list of examples follows. In some embodiments herein, the status of at least one QoS flow can be synchronized with a terminal device when the at least one QoS flow is managed by the first SMF and the second SMF. In some embodiments herein, V-SMF/I-SMF can handle the use case that the QoS flow deletion is not synced with UE when deleting is triggered. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1a shows a flowchart of UE or network requested PDU Session Modification (for non-roaming and roaming with local breakout);

FIG. 1b shows a flowchart of UE or network requested PDU Session Modification (home-routed roaming);

FIG. 2a schematically shows 5G system roaming architecture in the case of home routed scenario using the reference point representation according to an embodiment of the present disclosure;

FIG. 2b schematically shows non-roaming architecture with I-SMF insertion to the PDU session in reference point representation, with no Uplink Classifier (UL-CL)/Branching Point (BP) according to an embodiment of the present disclosure;

FIG. 3a shows a flowchart of a method according to an embodiment of the present disclosure;

FIG. 3b shows a flowchart of a method according to another embodiment of the present disclosure;

FIG. 3c shows a flowchart of a method according to another embodiment of the present disclosure;

FIG. 3d shows a flowchart of a method according to another embodiment of the present disclosure;

FIG. 3e shows a flowchart of a method according to another embodiment of the present disclosure;

FIG. 3f shows a flowchart of a method according to another embodiment of the present disclosure;

FIG. 3g shows a flowchart of a method according to another embodiment of the present disclosure;

FIG. 3h shows a flowchart of a method according to another embodiment of the present disclosure;

FIG. 4a shows a flowchart of a method according to another embodiment of the present disclosure;

FIG. 4b shows a flowchart of a method according to another embodiment of the present disclosure;

FIG. 4c shows a flowchart of a method according to another embodiment of the present disclosure;

FIG. 4d shows a flowchart of a method according to another embodiment of the present disclosure;

FIG. 4e shows a flowchart of a method according to another embodiment of the present disclosure;

FIG. 4f shows a flowchart of a method according to another embodiment of the present disclosure;

FIG. 4g shows a flowchart of a method according to another embodiment of the present disclosure;

FIG. 4h shows a flowchart of a method according to another embodiment of the present disclosure;

FIG. 5 shows a flowchart of UE or network requested PDU Session Modification procedure (home-routed roaming scenario) according to an embodiment of the present disclosure;

FIG. 6 shows a flowchart of UE Triggered Service Request procedure with I-SMF insertion/change/removal according to an embodiment of the present disclosure;

FIG. 7a shows a flowchart of network requested PDU Session Modification procedure according to an embodiment of the present disclosure;

FIG. 7b shows a flowchart of V-SMF/I-SMF insert procedure according to an embodiment of the present disclosure;

FIG. 7c shows a flowchart of V-SMF/I-SMF change procedure according to an embodiment of the present disclosure;

FIG. 7d shows a flowchart of PDU session modification procedure according to another embodiment of the present disclosure;

FIG. 8a is a block diagram showing an apparatus suitable for practicing some embodiments of the disclosure;

FIG. 8b is a block diagram showing a first SMF according to an embodiment of the disclosure; and

FIG. 9 is a block diagram showing a second SMF according to an embodiment of the disclosure.

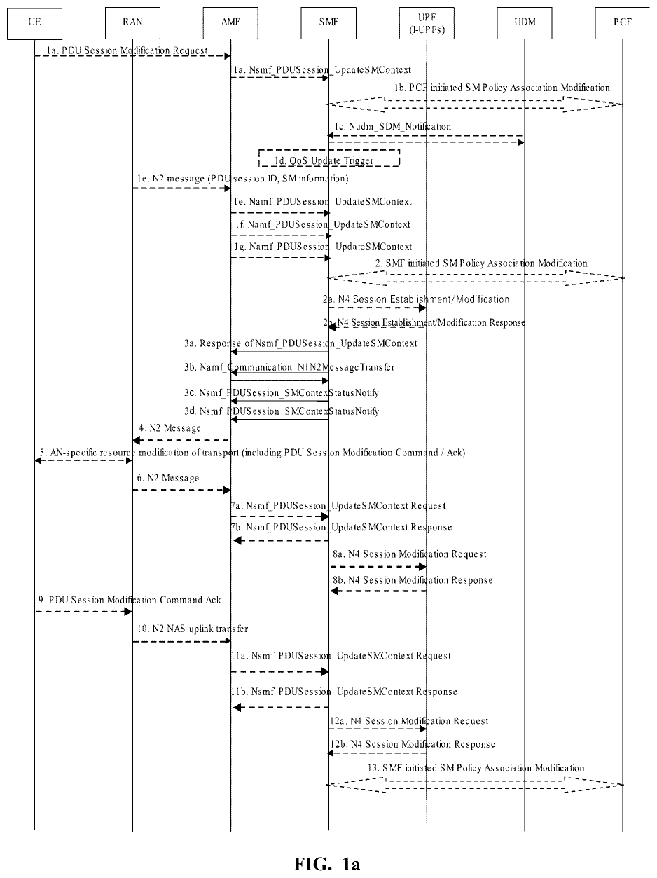

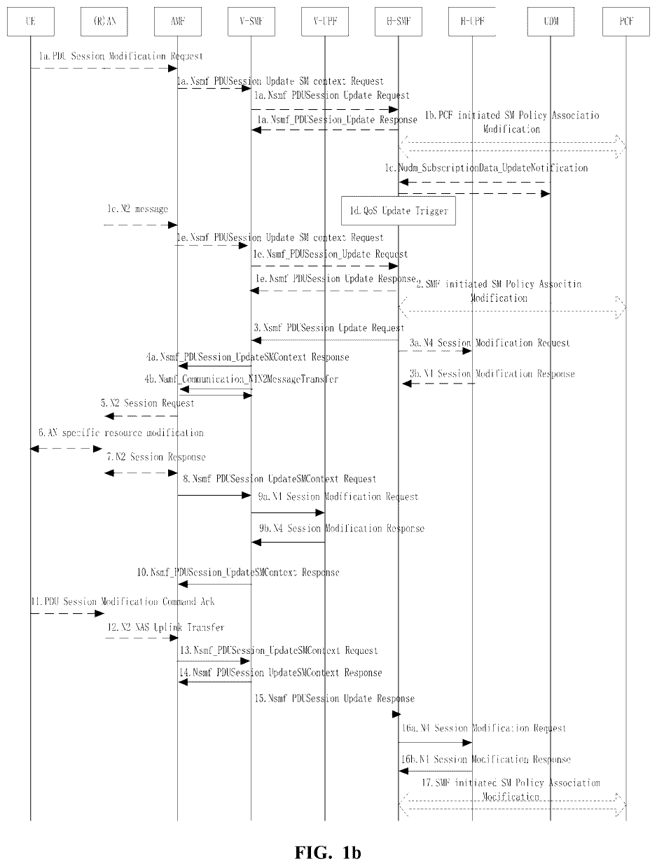

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G communication protocols, and/or any other protocols either currently known or to be developed in the future.

The term “network device” or “network node” refers to any suitable network function (NF) which can be implemented in a network entity (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and Mobility Management Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc. For example, the 4G system (such as LTE (Long Term Evolution)) may include MME (Mobile Management Entity), HSS (home subscriber server), Policy and Charging Rules Function (PCRF), Packet Data Network Gateway (PGW), PGW control plane (PGW-C), Serving gateway (SGW), SGW control plane (SGW-C), E-UTRAN Node B (eNB), etc. In other embodiments, the network function may comprise different types of NFs for example depending on a specific network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP (3rd Generation Partnership Project), such as 3GPP' LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

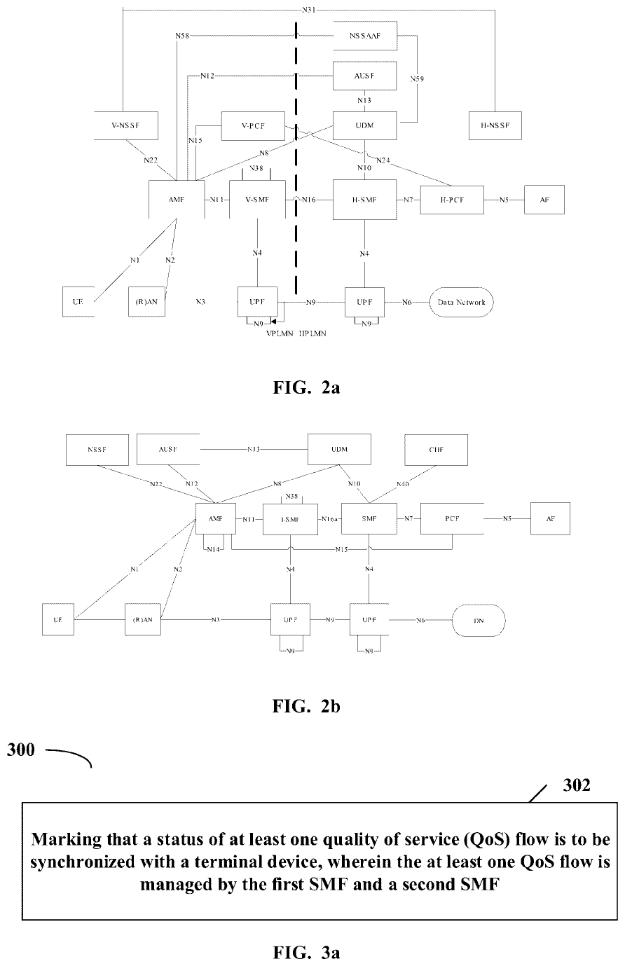

Although the subject matter described herein may be implemented in any appropriate type of system using any suitable components, the embodiments disclosed herein are described in relation to a communication system complied with the exemplary system architecture illustrated in FIGS. 2a-2b. For simplicity, the system architecture of FIGS. 2a-2b only depicts some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

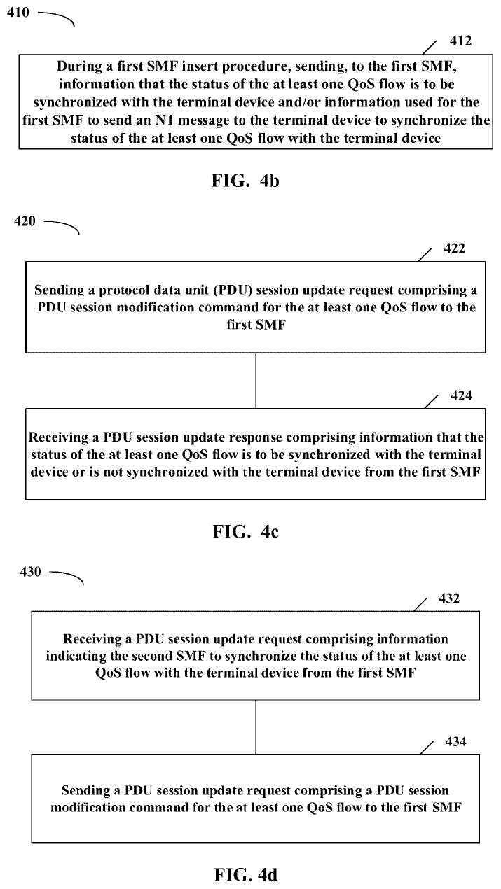

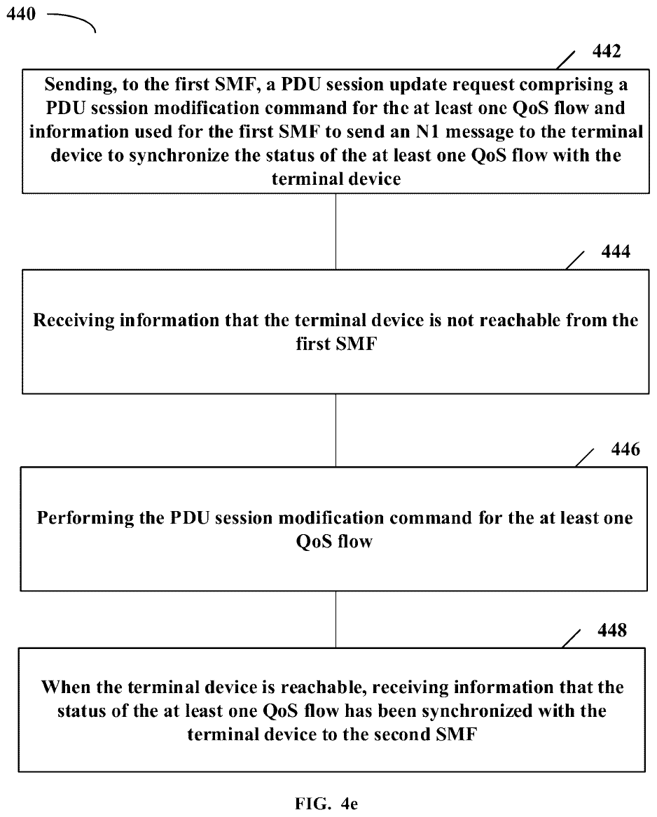

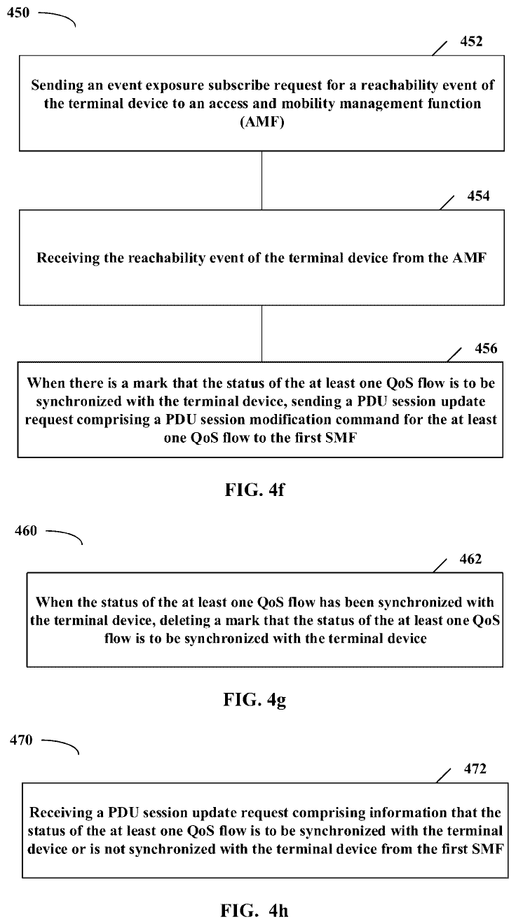

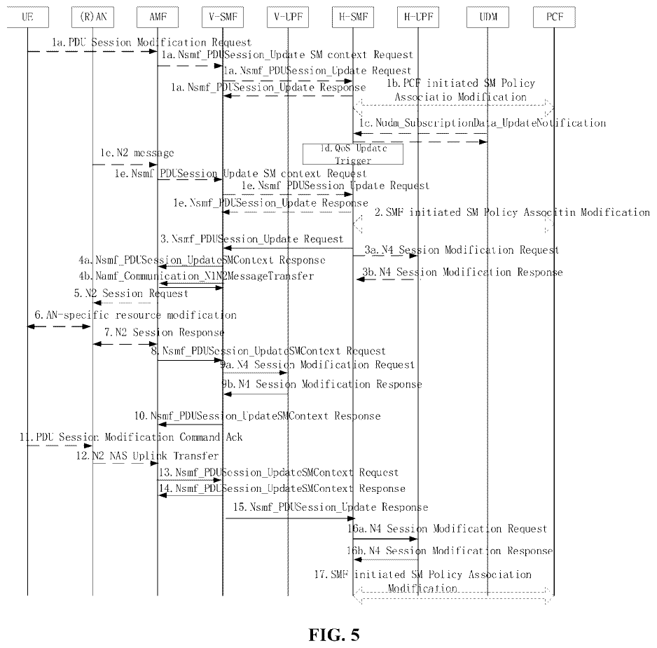

FIG. 2a schematically shows 5G system roaming architecture in the case of home routed scenario using the reference point representation according to an embodiment of the present disclosure. The architecture of FIG. 2a is same as FIG. 4.2.4-6 as described in 3GPP TS 23.501 V17.5.0, the disclosure of which is incorporated by reference herein in its entirety. The system architecture of FIG. 2a may comprise some exemplary elements such as AUSF, AMF, data network, visited NSSF (V-NSSF), home NSSF (H-NSSF), visited PCF (V-PCF), visited SMF (V-SMF), home SMF (H-SMF), UDM, UPF, AF, UE, (R)AN, NSSAAF (Network Slice-Specific Authentication and Authorization Function), etc.

In accordance with an exemplary embodiment, the UE can establish a signaling connection with the AMF over the reference point N1, as illustrated in FIG. 2a. This signaling connection may enable NAS (Non-access stratum) signaling exchange between the UE and the core network, comprising a signaling connection between the UE and the (R)AN and the N2 connection for this UE between the (R)AN and the AMF. The (R)AN can communicate with the UPF over the reference point N3. The UE can establish a protocol data unit (PDU) session to the data network (e.g. an operator network or Internet) through the UPF over the reference point N6.

The N38 references point can be between V-SMFs in the same VPLMN, or between V-SMFs in different VPLMNs (to enable inter-PLMN mobility).

For the roaming scenarios described above each PLMN implements proxy functionality to secure interconnection and hide topology on the inter-PLMN interfaces.

As further illustrated in FIG. 2a, it also shows some reference points such as N1, N2, N3, N4, N6, N9, N11, N38, N16, N7, N5, N22, N15, N8, N24, N10, N58, N12, N31, N59, N13 etc., which can support the interactions between NF services in the NFs. For example, these reference points may be realized through corresponding NF service-based interfaces and by specifying some NF service consumers and providers as well as their interactions in order to perform a particular system procedure.

Various NFs shown in FIG. 2a may be responsible for functions such as session management, mobility management, authentication, security, etc. Various NFs shown in FIG. 2a may include the functionality for example as defined in clause 6.2 of 3GPP TS 23.501 V17.5.0.

FIG. 2b schematically shows non-roaming architecture with I-SMF insertion to the PDU session in reference point representation, with no Uplink Classifier (UL-CL)/Branching Point (BP) according to an embodiment of the present disclosure. The architecture of FIG. 2b is same as FIG. 5.34.2.2-1 as described in 3GPP TS 23.501 V17.5.0, the disclosure of which is incorporated by reference herein in its entirety. The system architecture of FIG. 2b may comprise some exemplary elements such as AUSF, AMF, DN, NSSF, PCF, I-SMF, SMF, UDM, UPF, AF, UE, (R)AN, CHF (Charging Function), etc.

In accordance with an exemplary embodiment, the UE can establish a signaling connection with the AMF over the reference point N1, as illustrated in FIG. 2b. This signaling connection may enable NAS signaling exchange between the UE and the core network, comprising a signaling connection between the UE and the (R)AN and the N2 connection for this UE between the (R)AN and the AMF. The (R)AN can communicate with the UPF over the reference point N3. The UE can establish a PDU session to the data network (e.g. an operator network or Internet) through the UPF over the reference point N6.

N16a is the interface between SMF and I-SMF.

N38 is the interface between I-SMFs.

As further illustrated in FIG. 2b, it also shows some reference points such as N1, N2, N3, N4, N6, N9, N11, N14, N16a, N7, N5, N15, N38, N22, N12, N13, N8, N10, N40, N13, etc., which can support the interactions between NF services in the NFs. For example, these reference points may be realized through corresponding NF service-based interfaces and by specifying some NF service consumers and providers as well as their interactions in order to perform a particular system procedure.

Various NFs shown in FIG. 2b may be responsible for functions such as session management, mobility management, authentication, security, etc. Various NFs shown in FIG. 2b may include the functionality for example as defined in clause 6.2 of 3GPP TS 23.501 V17.5.0.

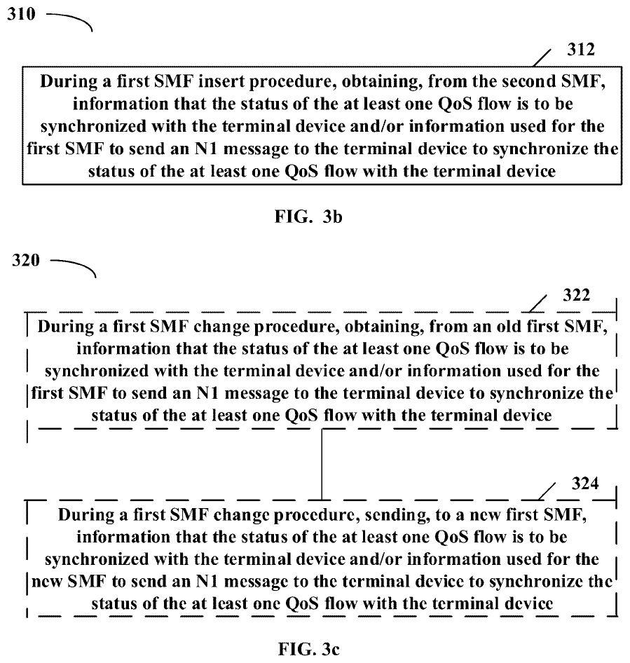

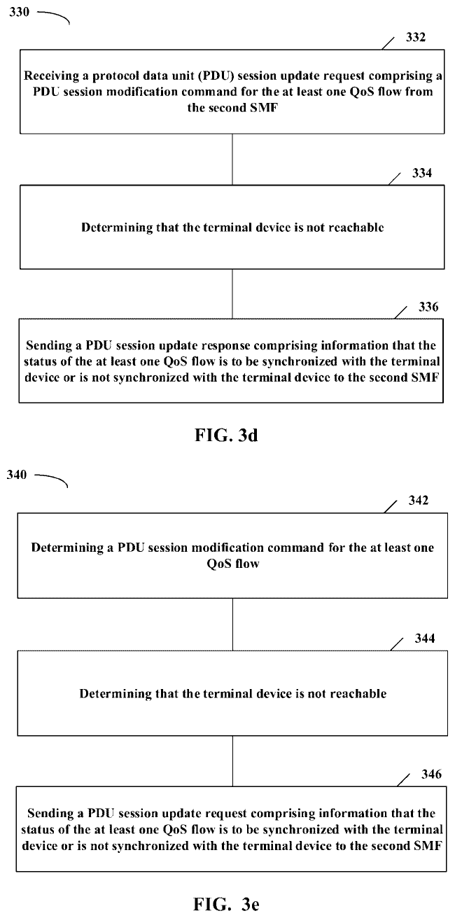

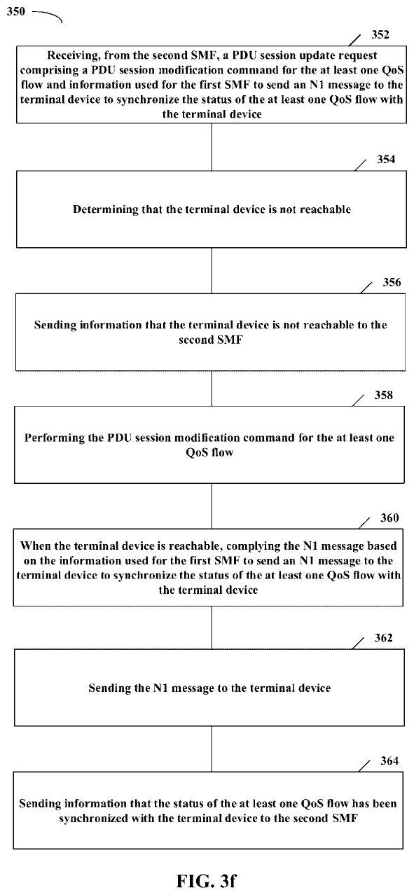

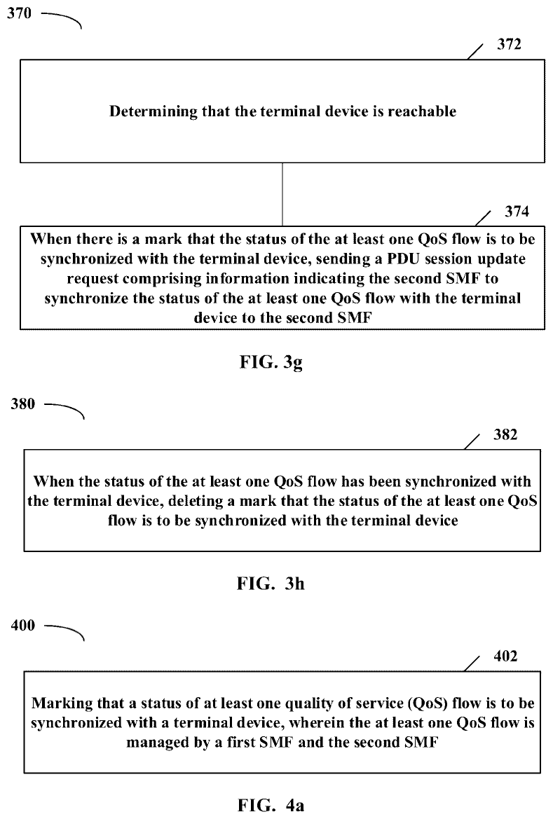

FIG. 3a shows a flowchart of a method according to an embodiment of the present disclosure, which may be performed by an apparatus implemented in or at or as a first session management function (SMF) or communicatively coupled to the first SMF. As such, the apparatus may provide means or modules for accomplishing various parts of the method 300 as well as means or modules for accomplishing other processes in conjunction with other components.

At block 302, the first SMF may mark that a status of at least one quality of service (QoS) flow is to be synchronized with a terminal device. The at least one QoS flow is managed by the first SMF and a second SMF.

In other embodiments, the mark that a status of at least one QoS flow is to be synchronized with a terminal device may be any other suitable marks which can enable the first SMF and the second SMF know that the status of at least one QoS flow is to be synchronized with the terminal device or the status of at least one QoS flow has not been synchronized with the terminal device. For example, the first SMF may mark that the status of at least one QoS flow has not been synchronized with the terminal device. The first SMF may mark N1 pending status indicating the QoS flow deletion is not synchronized with a terminal device due to user plane inactive.

The first SMF may be any suitable network device or node or entity or function which can support session management function. In an embodiment, the first SMF may be SMF as described in 3GPP TS 23.501 V17.5.0.

The second SMF may be any suitable network device or node or entity or function which can support session management function. In an embodiment, the second SMF may be SMF as described in 3GPP TS 23.501 V17.5.0.

In an embodiment, the first SMF may comprise at least one of an intermediate SMF (I-SMF), or a visited SMF. For example, the I-SMF may be an SMF that is inserted to support a PDU session as the UE is located in an area which cannot be controlled by the original SMF because the UPF(s) belong to a different SMF service area. For example, the V-SMF may be an SMF that is inserted to support a PDU session as the UE is located in a visited network which cannot be controlled by the home SMF because the UPF(s) belong to the visited network.

In an embodiment, the second SMF may comprise at least one of an SMF, or a home SMF (H-SMF) or an anchor SMF. For example, the H-SMF may be an SMF that is located in a home network.

For example, the first SMF may be I-SMF and the second SMF may be SMF or anchor SMF. The first SMF may be V-SMF and the second SMF may be H-SMF.

The at least one QoS flow may be any suitable QoS flow. The QoS flow may be the finest granularity for QoS forwarding treatment in the network. All traffic mapped to the same QoS Flow receives the same forwarding treatment (e.g. scheduling policy, queue management policy, rate shaping policy, RLC (Radio Link Control) configuration, etc.). Providing different QoS forwarding treatment requires separate QoS Flow. In an embodiment, the at least one QoS flow is not associated with a default QoS rule.

The status of at least one QoS flow may be any suitable status such as modification or deletion. In an embodiment, the status of at least one QoS flow comprises a deletion of at least one QoS flow.

The information that the status of the at least one QoS flow is to be synchronized with the terminal device may be obtained in various ways. For example, the first SMF may receive this information from the second SMF or an old first SMF or determine the information by itself. For example, during a PDU session modification procedure, the second SMF may determine to delete the at least one QoS flow and then it may send a PDU session update request comprising a command of deletion of the at least one QoS flow to the first SMF. When the terminal device is not reachable, the first SMF may determine this information. Alternatively, the first SMF may determine to modify (such as delete) the at least one QoS flow and when the terminal device is not reachable, the first SMF may determine this information. Alternatively, the first SMF may receive this information from the second SMF during a first SMF insert procedure or from an old first SMF during a first SMF change procedure.

FIG. 3b shows a flowchart of a method according to another embodiment of the present disclosure, which may be performed by an apparatus implemented in or at or as a first session management function (SMF) or communicatively coupled to the first SMF. As such, the apparatus may provide means or modules for accomplishing various parts of the method 310 as well as means or modules for accomplishing other processes in conjunction with other components. For some parts which have been described in the above embodiments, the description thereof is omitted here for brevity.

At block 312, during a first SMF insert procedure, the first SMF may obtain, from the second SMF, information that the status of the at least one QoS flow is to be synchronized with the terminal device and/or information used for the first SMF to send an N1 message to the terminal device to synchronize the status of the at least one QoS flow with the terminal device.

For example, when the terminal device is outside of the SMF service area, or current SMF cannot serve the target DNAI (DN Access Identifier) for the traffic routing for local access to the DN, an I-SMF is inserted between the SMF and the AMF.

In the case of roaming for a home routed PDU session, the following cases may occur:
A terminal device moves out of V-SMF serving area in the serving PLMN;
A terminal device moves to another (serving) VPLMN;
A terminal device moves between HPLMN (home PLMN) and a VPLMN.

In the above cases, the procedures in clauses 4.23.2-16 of 3GPP TS 23.502 V17.5.0 for I-SMF apply for the V-SMF insertion/change/removal by replacing the I-SMF with V-SMF, and SMF with H-SMF.

For an established PDU session, an I-SMF is inserted if the UE is not in the SMF service area. In this case, when an UE moves from HPLMN to a VPLMN, a V-SMF is inserted and the I-SMF is removed. For mobility from VPLMN to HPLMN, an I-SMF is inserted and the V-SMF is removed. The procedures apply in this case, i.e. by replacing the target or new I-SMF by a V-SMF for mobility from HPLMN to VPLMN and by replacing the source or old I-SMF by a V-SMF for mobility from VPLMN to HPLMN.

For example, the AMF may select an SMF serving the PDU Session. If the service area of the selected SMF does not control user plane function that can serve the UE location, the AMF selects an I-SMF. After the PDU Session is established, if the selected SMF cannot serve the target DNAI requested by the Policy and Charging Control (PCC) rule, the SMF may issue PDU Session SM (session management) Context Status Notify to provide the target DNAI information to the AMF. Then AMF selects an I-SMF that serves this target DNAI. For home routed roaming case, the AMF may select V-SMF and reselect V-SMF.

In an embodiment, the first SMF insert procedure may be same or similar to the UE Triggered Service Request procedure with I-SMF insertion procedure as described in clause 4.23.4.3 of 3GPP TS 23.502 V17.5.0.

For example, the second SMF may mark that a status of at least one quality of service (QoS) flow is to be synchronized with a terminal device. Then during the first SMF insert procedure, the second SMF may send, to the first SMF, information that the status of the at least one QoS flow is to be synchronized with the terminal device and/or information used for the first SMF to send an N1 message to the terminal device to synchronize the status of the at least one QoS flow with the terminal device.

In an embodiment, the N1 message may be same as the corresponding message as described in 3GPP TS 23.502 V17.5.0.

These information may be obtained in any suitable message such as new message or existing message. For example, during a SMF insert procedure, the first SMF may send Nsmf_PDUSession_Context Request as described in 3GPP TS 23.502 V17.5.0 to the second SMF. Then the first SMF may receive from the second SMF a Nsmf_PDUSession_Context Response as described in 3GPP TS 23.502 V17.5.0 comprising the information that the status of the at least one QoS flow is to be synchronized with the terminal device and/or the information used for the first SMF to send an N1 message to the terminal device to synchronize the status of the at least one QoS flow with the terminal device.

FIG. 3c shows a flowchart of a method according to another embodiment of the present disclosure, which may be performed by an apparatus implemented in or at or as a first session management function (SMF) or communicatively coupled to the first SMF. As such, the apparatus may provide means or modules for accomplishing various parts of the method 320 as well as means or modules for accomplishing other processes in conjunction with other components. For some parts which have been described in the above embodiments, the description thereof is omitted here for brevity.

At block 322, optionally, during a first SMF change procedure, the first SMF may obtain, from an old first SMF, information that the status of the at least one QoS flow is to be synchronized with the terminal device and/or information used for the first SMF to send an N1 message to the terminal device to synchronize the status of the at least one QoS flow with the terminal device.

For example, when the terminal device moves from old I-SMF service area to new I-SMF service area, the I-SMF is changed (i.e. I-SMF change).

In an embodiment, the first SMF change procedure may be same as the UE Triggered Service Request with I-SMF change procedure as described in clause 4.23.4.3 of 3GPP TS 23.502 V17.5.0.

In an embodiment, after obtaining the information that the status of the at least one QoS flow is to be synchronized with the terminal device, the first SMF may mark that the status of the at least one QoS flow is to be synchronized with the terminal device.

In an embodiment, when the terminal device is reachable and the status of the at least one QoS flow is to be synchronized with the terminal device is marked, the first SMF may use the information to comply the N1 message and send the N1 message to the terminal device to synchronize the status of the at least one QoS flow with the terminal device.

In an embodiment, when the terminal device is reachable and the status of the at least one QoS flow is to be synchronized with the terminal device is marked, the first SMF may send a PDU session update request comprising information indicating the second SMF to synchronize the status of the at least one QoS flow with the terminal device to the second SMF.

These information may be obtained in any suitable message such as new message or existing message. For example, during a SMF change procedure, the first SMF as a new I-SMF may send Nsmf_PDUSession_Context Request to the second SMF as an old first SMF. Then the first SMF may receive from the second SMF an Nsmf_PDUSession_Context Response comprising the information that the status of the at least one QoS flow is to be synchronized with the terminal device and/or the information used for the first SMF to send an N1 message to the terminal device to synchronize the status of the at least one QoS flow with the terminal device.

At block 324, optionally, during a first SMF change procedure, the first SMF may send, to a new first SMF, information that the status of the at least one QoS flow is to be synchronized with the terminal device and/or information used for the new SMF to send an N1 message to the terminal device to synchronize the status of the at least one QoS flow with the terminal device.

For example, when the terminal device moves from old I-SMF service area to new I-SMF service area, the I-SMF is changed (i.e. I-SMF change).

In an embodiment, the first SMF change procedure may be same as the UE Triggered Service Request with I-SMF change procedure as described in clause 4.23.4.3 of 3GPP TS 23.502 V17.5.0.

In an embodiment, after obtaining the information that the status of the at least one QoS flow is to be synchronized with the terminal device, the new first SMF may mark that the status of the at least one QoS flow is to be synchronized with the terminal device.

In an embodiment, when the terminal device is reachable and the status of the at least one QoS flow is to be synchronized with the terminal device is marked, the new first SMF may use the information to comply the N1 message and send the N1 message to the terminal device to synchronize the status of the at least one QoS flow with the terminal device.

In an embodiment, when the terminal device is reachable and the status of the at least one QoS flow is to be synchronized with the terminal device is marked, the new first SMF may send a PDU session update request comprising information indicating the second SMF to synchronize the status of the at least one QoS flow with the terminal device to the second SMF.

These information may be sent in any suitable message such as new message or existing message. For example, during a SMF change procedure, the new first SMF may send Nsmf_PDUSession_Context Request to the first SMF as an old first SMF. Then the first SMF may send to the new first SMF an Nsmf_PDUSession_Context Response comprising the information that the status of the at least one QoS flow is to be synchronized with the terminal device and/or the information used for the first SMF to send an N1 message to the terminal device to synchronize the status of the at least one QoS flow with the terminal device.

FIG. 3d shows a flowchart of a method according to another embodiment of the present disclosure, which may be performed by an apparatus implemented in or at or as a first session management function (SMF) or communicatively coupled to the first SMF. As such, the apparatus may provide means or modules for accomplishing various parts of the method 330 as well as means or modules for accomplishing other processes in conjunction with other components. For some parts which have been described in the above embodiments, the description thereof is omitted here for brevity.

At block 332, the first SMF may receive a protocol data unit (PDU) session update request comprising a PDU session modification command for the at least one QoS flow from the second SMF.

The PDU session modification command may be any suitable PDU session modification command such as deletion or modification of at least one QoS flow, etc.

For example, the PDU session update request may be Nsmf_PDUSession_Update Request as described in clause 4.3.3.3 of 3GPP TS 23.502 V17.5.0.

For example, during the UE or network requested PDU Session Modification procedure (home-routed roaming scenario) as described in clause 4.3.3.3 of 3GPP TS 23.502 V17.5.0, the first SMF such as I-SMF/V-SMF may receive the Nsmf_PDUSession_Update Request from the second SMF such as SMF/H-SMF.

At block 334, the first SMF may determine that the terminal device is not reachable. The first SMF may determine that the terminal device is not reachable in various ways. For example, the first SMF receive a notification that the terminal device does not respond. The first SMF (V-SMF/I-SMF) can subscribe to an event for “UE Reachability Status Change” to receive the current reachability state of a UE or a group of UEs in the AMF, and report for updated reachability state of a UE or any UE in the group when AMF becomes aware of a reachability state change of the UEs between reachable, unreachable, regulatory-only.

Then the first SMF may mark that a status of at least one quality of service (QoS) flow is to be synchronized with a terminal device. The at least one QoS flow is managed by the first SMF and a second SMF.

At block 336, the first SMF may send a PDU session update response comprising information that the status of the at least one QoS flow is to be synchronized with the terminal device or is not synchronized with the terminal device to the second SMF.

For example, during the UE or network requested PDU Session Modification procedure (home-routed roaming scenario) as described in clause 4.3.3.3 of 3GPP TS 23.502 V17.5.0, the first SMF (such as V-SMF or I-SMF) may receive a protocol data unit (PDU) session update request comprising a PDU session modification command for the at least one QoS flow from the second SMF (such as H-SMF or SMF). The first SMF may determine that the terminal device is not reachable. The first SMF may send a PDU session update response comprising information that the status of the at least one QoS flow is to be synchronized with the terminal device or is not synchronized with the terminal device to the second SMF.

FIG. 3e shows a flowchart of a method according to another embodiment of the present disclosure, which may be performed by an apparatus implemented in or at or as a first session management function (SMF) or communicatively coupled to the first SMF. As such, the apparatus may provide means or modules for accomplishing various parts of the method 340 as well as means or modules for accomplishing other processes in conjunction with other components. For some parts which have been described in the above embodiments, the description thereof is omitted here for brevity.

At block 342, the first SMF may determine a PDU session modification command for the at least one QoS flow.

The PDU session modification command may be any suitable PDU session modification command such as deletion or modification of at least one QoS flow, etc.

In an embodiment, the at least one QoS flow comprises at least one guaranteed bit rate (GBR) QoS flow or GBR dedicated QoS flow.

In an embodiment, the PDU session modification command for the at least one QoS flow is determined during an access network release procedure. For example, the access network release procedure may be AN Release procedure involving I-SMF as described in clause 4.23.8 of 3GPP TS 23.502 V17.5.0.

For example, when the first SMF such as V-SMF/I-SMF finds GBR dedicated QoS flow should be released during AN (access network) release procedure but UE is not reachable according to the ngApCause (Next Generation Application Protocol (NGAP) cause) in AN release. The first SMF such as V-SMF/I-SMF sends the N1 pending status which indicate that current terminal device is not reachable to the second SMF such as A-SMF/H-SMF. Then A-SMF/H-SMF marks that the QoS flow is deleted but pend the N1 QoS flow delete message to UE.

At block 344, the first SMF may determine that the terminal device is not reachable.

The first SMF may determine that the terminal device is not reachable in various ways. For example, the first SMF receive a notification that the terminal device does not respond. The first SMF (V-SMF/I-SMF) can subscribe to an event for “UE Reachability Status Change” to receive the current reachability state of a UE or a group of UEs in the AMF, and report for updated reachability state of a UE or any UE in the group when AMF becomes aware of a reachability state change of the UEs between reachable, unreachable, regulatory-only.

Then the first SMF may mark that a status of at least one quality of service (QoS) flow is to be synchronized with a terminal device. The at least one QoS flow is managed by the first SMF and a second SMF.

At block 346, the first SMF may send a PDU session update request comprising information that the status of the at least one QoS flow is to be synchronized with the terminal device or is not synchronized with the terminal device to the second SMF.

FIG. 3f shows a flowchart of a method according to another embodiment of the present disclosure, which may be performed by an apparatus implemented in or at or as a first session management function (SMF) or communicatively coupled to the first SMF. As such, the apparatus may provide means or modules for accomplishing various parts of the method 350 as well as means or modules for accomplishing other processes in conjunction with other components. For some parts which have been described in the above embodiments, the description thereof is omitted here for brevity.

At block 352, the first SMF may receive, from the second SMF, a PDU session update request comprising a PDU session modification command for the at least one QoS flow and information used for the first SMF to send an N1 message to the terminal device to synchronize the status of the at least one QoS flow with the terminal device.

The PDU session modification command may be any suitable PDU session modification command such as deletion or modification of at least one QoS flow, etc.

For example, the PDU session update request may be Nsmf_PDUSession_Update Request as described in clause 4.3.3.3 of 3GPP TS 23.502 V17.5.0.

For example, during the UE or network requested PDU Session Modification procedure (home-routed roaming scenario) as described in clause 4.3.3.3 of 3GPP TS 23.502 V17.5.0, the first SMF such as I-SMF/V-SMF may receive the Nsmf_PDUSession_Update Request from the second SMF such as SMF/H-SMF.

At block 354, the first SMF may determine that the terminal device is not reachable.

The first SMF may determine that the terminal device is not reachable in various ways. For example, the first SMF receive a notification that the terminal device does not respond. The first SMF (V-SMF/I-SMF) can subscribe to an event for “UE Reachability Status Change” to receive the current reachability state of a UE or a group of UEs in the AMF, and report for updated reachability state of a UE or any UE in the group when AMF becomes aware of a reachability state change of the UEs between reachable, unreachable, regulatory-only.

At block 356, the first SMF may send information that the terminal device is not reachable to the second SMF.

At block 358, the first SMF may perform the PDU session modification command for the at least one QoS flow.

At block 360, when the terminal device is reachable, the first SMF may comply the N1 message based on the information used for the first SMF to send an N1 message to the terminal device to synchronize the status of the at least one QoS flow with the terminal device.

At block 362, the first SMF may send the N1 message to the terminal device.

At block 364, the first SMF may send information that the status of the at least one QoS flow has been synchronized with the terminal device to the second SMF.

For example, the second SMF such as H-SMF/A-SMF may sends a QoS flow deletion command to the first SMF such as V-SMF/I-SMF in N16 interface with QoS flow information and n1smInfoToUE (as described in 3GPP TS 29.502 V18.0.0). When the first SMF such as V-SMF/I-SMF finds that the UE is not reachable, the first SMF such as V-SMF/I-SMF still triggers QoS flow release and sends the UE not reachable status to the second SMF such as H-SMF/A-SMF. Both the second SMF such as H-SMF/A-SMF and the first SMF such as V-SMF/I-SMF may delete this QoS flow. Both the second SMF such as H-SMF/A-SMF and the first SMF such as V-SMF/I-SMF mark that N1 message that the QoS flow delete is not sent to UE.

After UE is reachable again with service request, the first SMF such as V-SMF/I-SMF compiles the N1 message according to the stored N1 message information and give the N1 pending status to the second SMF such as H-SMF/A-SMF (anchor SMF) that N1 message has already been sent to UE, so both the second SMF such as H-SMF/A-SMF and the first SMF such as V-SMF/I-SMF remove this mark.

During new first SMF such as V-SMF/I-SMF insert, the second SMF such as H-SMF/A-SMF may send this N1 pending status and all information which is used for V-SMF/I-SMF to send NAS message to UE in SMContext as described in 3GPP TS 23.502 V17.5.0.

During new first SMF such as V-SMF/I-SMF change, old first SMF such as V-SMF/I-SMF may send this N1 pending status and all information which is used for the new first SMF such as V-SMF/I-SMF to send NAS message to UE in SMContext.

In some embodiments, the PDU session modification command comprises a deletion of the at least one QoS flow.

FIG. 3g shows a flowchart of a method according to another embodiment of the present disclosure, which may be performed by an apparatus implemented in or at or as a first session management function (SMF) or communicatively coupled to the first SMF. As such, the apparatus may provide means or modules for accomplishing various parts of the method 370 as well as means or modules for accomplishing other processes in conjunction with other components. For some parts which have been described in the above embodiments, the description thereof is omitted here for brevity.

At block 372, the first SMF may determine that the terminal device is reachable.

For example, the first SMF such as V-SMF/I-SMF may find that the terminal device can be reachable during service request procedure. The first SMF such as V-SMF/I-SMF may can subscribe to the event for “UE Reachability Status Change” to receive the current reachability state of a UE or a group of UEs in the AMF, and report for updated reachability state of a UE or any UE in the group when AMF becomes aware of a reachability state change of the UEs between reachable, unreachable, regulatory only.

At block 374, when there is a mark that the status of the at least one QoS flow is to be synchronized with the terminal device, the first SMF may send a PDU session update request comprising information indicating the second SMF to synchronize the status of the at least one QoS flow with the terminal device to the second SMF.

For example, during service request procedure, the first SMF may send a PDU session update request comprising information indicating the second SMF to synchronize the status of the at least one QoS flow with the terminal device to the second SMF.

FIG. 3h shows a flowchart of a method according to another embodiment of the present disclosure, which may be performed by an apparatus implemented in or at or as a first session management function (SMF) or communicatively coupled to the first SMF. As such, the apparatus may provide means or modules for accomplishing various parts of the method 380 as well as means or modules for accomplishing other processes in conjunction with other components. For some parts which have been described in the above embodiments, the description thereof is omitted here for brevity.

At block 382, when the status of the at least one QoS flow has been synchronized with the terminal device, the first SMF may delete a mark that the status of the at least one QoS flow is to be synchronized with the terminal device.

For example, when the first SMF has synchronized the status of the at least one QoS flow with the terminal device, the first SMF may delete a mark that the status of the at least one QoS flow is to be synchronized with the terminal device.

FIG. 4a shows a flowchart of a method according to another embodiment of the present disclosure, which may be performed by an apparatus implemented in or at or as a second SMF or communicatively coupled to the second SMF. As such, the apparatus may provide means or modules for accomplishing various parts of the method 400 as well as means or modules for accomplishing other processes in conjunction with other components. For some parts which have been described in the above embodiments, the description thereof is omitted here for brevity.

At block 402, the second SMF may mark that a status of at least one quality of service (QoS) flow is to be synchronized with a terminal device. The at least one QoS flow is managed by a first SMF and the second SMF.

In other embodiments, the mark that a status of at least one QoS flow is to be synchronized with a terminal device may be any other suitable marks which can enable the first SMF and the second SMF know that the status of at least one QoS flow is to be synchronized with the terminal device or the status of at least one QoS flow has not been synchronized with the terminal device. For example, the second SMF may mark that the status of at least one QoS flow has not been synchronized with the terminal device. The second SMF may mark N1 pending status indicating the QoS flow deletion is not synchronized with a terminal device due to user plane inactive.

In an embodiment, the first SMF may comprise at least one of an intermediate SMF (I-SMF), or a visited SMF.

In an embodiment, the second SMF may comprise at least one of an SMF, or a home SMF (H-SMF) or an anchor SMF.

In an embodiment, the at least one QoS flow is not associated with a default QoS rule.

In an embodiment, the status of at least one QoS flow comprises a deletion of at least one QoS flow.

The information that the status of the at least one QoS flow is to be synchronized with the terminal device may be obtained in various ways. For example, the second SMF may receive this information from the first SMF or determine the information by itself. For example, during a PDU session modification procedure, the second SMF may determine to delete the at least one QoS flow and then it may send a PDU session update request comprising a command of deletion of the at least one QoS flow to the first SMF. When the terminal device is not reachable, the first SMF may determine this information and send it to the second SMF. Alternatively, the second SMF may determine to modify (such as delete) the at least one QoS flow and when the terminal device is not reachable, the second SMF may determine this information.

FIG. 4b shows a flowchart of a method according to another embodiment of the present disclosure, which may be performed by an apparatus implemented in or at or as a second SMF or communicatively coupled to the second SMF. As such, the apparatus may provide means or modules for accomplishing various parts of the method 410 as well as means or modules for accomplishing other processes in conjunction with other components. For some parts which have been described in the above embodiments, the description thereof is omitted here for brevity.

At block 412, during a first SMF insert procedure, the second SMF may send, to the first SMF, information that the status of the at least one QoS flow is to be synchronized with the terminal device and/or information used for the first SMF to send an N1 message to the terminal device to synchronize the status of the at least one QoS flow with the terminal device.

FIG. 4c shows a flowchart of a method according to another embodiment of the present disclosure, which may be performed by an apparatus implemented in or at or as a second SMF or communicatively coupled to the second SMF. As such, the apparatus may provide means or modules for accomplishing various parts of the method 420 as well as means or modules for accomplishing other processes in conjunction with other components. For some parts which have been described in the above embodiments, the description thereof is omitted here for brevity.

At block 422, the second SMF may send a protocol data unit (PDU) session update request comprising a PDU session modification command for the at least one QoS flow to the first SMF.

At block 424, the second SMF may receive a PDU session update response comprising information that the status of the at least one QoS flow is to be synchronized with the terminal device or is not synchronized with the terminal device from the first SMF.

In an embodiment, the second SMF may mark that a status of at least one quality of service (QoS) flow is to be synchronized with a terminal device. The at least one QoS flow is managed by a first SMF and the second SMF.

FIG. 4d shows a flowchart of a method according to another embodiment of the present disclosure, which may be performed by an apparatus implemented in or at or as a second SMF or communicatively coupled to the second SMF. As such, the apparatus may provide means or modules for accomplishing various parts of the method 430 as well as means or modules for accomplishing other processes in conjunction with other components. For some parts which have been described in the above embodiments, the description thereof is omitted here for brevity.

At block 432, the second SMF may receive a PDU session update request comprising information indicating the second SMF to synchronize the status of the at least one QoS flow with the terminal device from the first SMF.

At block 434, the second SMF may send a PDU session update request comprising a PDU session modification command for the at least one QoS flow to the first SMF.

FIG. 4e shows a flowchart of a method according to another embodiment of the present disclosure, which may be performed by an apparatus implemented in or at or as a second SMF or communicatively coupled to the second SMF. As such, the apparatus may provide means or modules for accomplishing various parts of the method 440 as well as means or modules for accomplishing other processes in conjunction with other components. For some parts which have been described in the above embodiments, the description thereof is omitted here for brevity.

At block 442, the second SMF may send, to the first SMF, a PDU session update request comprising a PDU session modification command for the at least one QoS flow and information used for the first SMF to send an N1 message to the terminal device to synchronize the status of the at least one QoS flow with the terminal device.

At block 444, the second SMF may receive information that the terminal device is not reachable from the first SMF.

In an embodiment, the second SMF may mark that a status of at least one quality of service (QoS) flow is to be synchronized with a terminal device. The at least one QoS flow is managed by a first SMF and the second SMF.

At block 446, the second SMF may perform the PDU session modification command for the at least one QoS flow.

At block 448, when the terminal device is reachable, the second SMF may receive information that the status of the at least one QoS flow has been synchronized with the terminal device to the second SMF.

FIG. 4f shows a flowchart of a method according to another embodiment of the present disclosure, which may be performed by an apparatus implemented in or at or as a second SMF or communicatively coupled to the second SMF. As such, the apparatus may provide means or modules for accomplishing various parts of the method 450 as well as means or modules for accomplishing other processes in conjunction with other components. For some parts which have been described in the above embodiments, the description thereof is omitted here for brevity.

At block 452, the second SMF may send an event exposure subscribe request for a reachability event of the terminal device to an access and mobility management function (AMF).

At block 454, the second SMF may receive the reachability event of the terminal device from the AMF.

At block 456, when there is a mark that the status of the at least one QoS flow is to be synchronized with the terminal device, the second SMF may send a PDU session update request comprising a PDU session modification command for the at least one QoS flow to the first SMF.

In some embodiments, the PDU session modification command comprises a deletion of the at least one QoS flow.

FIG. 4g shows a flowchart of a method according to another embodiment of the present disclosure, which may be performed by an apparatus implemented in or at or as a second SMF or communicatively coupled to the second SMF. As such, the apparatus may provide means or modules for accomplishing various parts of the method 460 as well as means or modules for accomplishing other processes in conjunction with other components. For some parts which have been described in the above embodiments, the description thereof is omitted here for brevity.

At block 462, when the status of the at least one QoS flow has been synchronized with the terminal device, the second SMF may delete a mark that the status of the at least one QoS flow is to be synchronized with the terminal device.

For example, when the second SMF has synchronized the status of the at least one QoS flow with the terminal device or receives an indication that the status of the at least one QoS flow has been synchronized with the terminal device, the second SMF may delete a mark that the status of the at least one QoS flow is to be synchronized with the terminal device.

FIG. 4h shows a flowchart of a method according to another embodiment of the present disclosure, which may be performed by an apparatus implemented in or at or as a second SMF or communicatively coupled to the second SMF. As such, the apparatus may provide means or modules for accomplishing various parts of the method 470 as well as means or modules for accomplishing other processes in conjunction with other components. For some parts which have been described in the above embodiments, the description thereof is omitted here for brevity.

At block 472, the second SMF may receive a PDU session update request comprising information that the status of the at least one QoS flow is to be synchronized with the terminal device or is not synchronized with the terminal device from the first SMF.

In an embodiment, the second SMF may mark that a status of at least one quality of service (QoS) flow is to be synchronized with a terminal device. The at least one QoS flow is managed by a first SMF and the second SMF.

In an embodiment, the at least one QoS flow comprises at least one guaranteed bit rate (GBR) QoS flow.

FIG. 5 shows a flowchart of UE or network requested PDU Session Modification procedure (home-routed roaming scenario) according to an embodiment of the present disclosure.

Clause 4.3.3.3 of 3GPP TS 23.502 V17.5.0 may be amended as following underline content.

1. The procedure is triggered by one of the following events:

1a. (UE or serving network requested) As in step 1a of clause 4.3.3.2 of 3GPP TS 23.502 V17.5.0 with the addition that:
The V-SMF checks whether it can accept the request from the UE;
The V-SMF invokes an Nsmf_PDUSession_Update Request (SM Context ID, UE request for PDU Session Modification or the QoS modification request from the VPLMN, UE location information, Time Zone, the current Access Type, PCO, [Always-on PDU Session Requested]) service operation to inform the H-SMF to update the PDU Session. The H-SMF responds to the request immediately. If the AMF notified the V-SMF that the access type of the PDU session can be changed, as described in the UE Triggered Service Request procedure in clause 4.2.3.2 of 3GPP TS 23.502 V17.5.0, the V-SMF shall also indicate that the access type can be changed.

The PS Data Off status, if changed, shall be included in PCO (Protocol Configuration Option) in the PDU Session Modification Request message.

When PCF is deployed, the SMF shall further report the PS Data Off status to PCF if the PS Data Off event trigger is provisioned, the additional behaviour of SMF and PCF for 3GPP PS Data Off is defined in 3GPP TS 23.503.

1b. (HPLMN requested) This step is the same as step 1b in clause 4.3.3.2 of 3GPP TS 23.502 V17.5.0. If the H-SMF received the indication that the access type of the PDU session can be changed, the H-SMF shall indicate the target access type to the PCF in the Access Type information of the Npcf_SMPolicyControl_Update Request.

1c. (HPLMN requested) This step is the same as step 1c in clause 4.3.3.2 of 3GPP TS 23.502 V17.5.0.

1d. (HPLMN requested) This step is the same as step 1d in clause 4.3.3.2 of 3GPP TS 23.502 V17.5.0 with the following difference:

When the modification procedure is triggered to synchronize status of QoS Flow(s) with the UE, the H-SMF initiates the modification when receiving indication from V-SMF to synchronize the status of QoS Flow(s) with the UE at UP connection activation in Service Request.

NOTE x: How H-SMF receives indication to synchronize the status of QoS Flow(s) with the UE at UP connection activation in Service Request, refer to the following amended clauses 4.23.4.2 and 4.23.4.3 of 3GPP TS 23.502 V17.5.0.

1e. As in step 1e of clause 4.3.3.2 of 3GPP TS 23.502 V17.5.0 with addition that:
The AMF invokes Nsmf_PDUSession_UpdateSMContext (SM context ID, N2 SM information) and sends it to the V-SMF;
The V-SMF invokes an Nsmf_PDUSession_Update Request (SM context ID, ULI, AN type, QoS Flow to be released) service operation to inform the H-SMF to update the PDU Session. The H-SMF responds to the request immediately. For AN initiated notification control in step 1e of clause 4.3.3.2 of 3GPP TS 23.502 V17.5.0, the V-SMF includes also QoS Flow notification information as specified in clause 5.7 of 3GPP TS 23.501 V17.5.0.

NOTE 1: SM Context ID between AMF and V-SMF and between V-SMF and H-SMF are different. SM Context ID has local significance per SMF instance.

2. This step is the same as steps 2 in clause 4.3.3.2 of 3GPP TS 23.502 V17.5.0 with the SMF is H-SMF.

3. (UE or serving network requested or HPLMN requested) The H-SMF invokes the Nsmf_PDUSession_Update Request (SM Context ID, QoS profiles, [Alternative QoS profile(s)], Session-AMBR, information needed to build the SM PDU Session Modification Command message towards the UE including the QoS rule(s) and QoS Flow level QoS parameters if needed for the QoS Flow(s) associated with the QoS rule(s) and QoS rule operation and the QoS Flow level QoS parameters operation) service operation to the V-SMF.

Based on operator policies and roaming agreements, the V-SMF may decide to fully accept or reject the QoS information provided by the H-SMF. The V-SMF shall also be able to accept a subset of the QoS flows requested to be created or modified within a single H-SMF request i.e. V-SMF can accept some QoS flows and reject other QoS flows in same response to H-SMF.

3a-3b (HPLMN requested) These steps are executed if new QoS Flow(s) are to be created. The SMF updates the UPF with UL Packet Detection Rules of the new QoS Flow.

NOTE 2: This allows the UL packets with the QFI of the new QoS Flow to be transferred.

If an Always-on PDU Session Granted indication was provided by the H-SMF to indicate that the PDU Session is to be changed to an always-on PDU Session, the V-SMF decides whether to accept or reject the request from the H-SMF based on local policies.

4a-4b. These steps are the same as step 3a-3b in clause 4.3.3.2 of 3GPP TS 23.502 V17.5.0 but controlled from the V-SMF. The V-SMF uses the information received in step 3 to generate any N1 and/or N2 signalling to be sent towards the UE and/or the (R)AN.

5-7. These steps are the same as step 4-6 in clause 4.3.3.2 of 3GPP TS 23.502 V17.5.0.

8. This step is the same as step 7a in clause 4.3.3.2 of 3GPP TS 23.502 V17.5.0 with the difference that the SMF is V-SMF.

If the N2 SM information indicates modification failure and the V-SMF rejected the PDU session modification as described in step 7 in clause 4.3.3.2 of 3GPP TS 23.502 V17.5.0, step 9 is skipped.

9a-9b are the same as step 8a-8b in clause 4.3.3.2 of 3GPP TS 23.502 V17.5.0 but executed in Visited PLMN

10. This step is the same as step 7b in clause 4.3.3.2 of 3GPP TS 23.502 V17.5.0 with the difference that the SMF is V-SMF.

11-12. These steps are the same as steps 8-9 in 4.3.3.2 of 3GPP TS 23.502 V17.5.0.

13-14. These steps are the same as step 11a-11b in clause 4.3.3.2 of 3GPP TS 23.502 V17.5.0 but executed in Visited PLMN.

15. V-SMF responds to the H-SMF with an Nsmf_PDUSession_Update response carrying the information like PCO provided by the UE in the SM PDU Session Modification Command Ack message from the UE to the V-SMF, Secondary RAT usage data. The H-SMF shall modify the PDU Session context.

If the V-SMF has rejected QFI(s) (step3) or the (R)AN has rejected QFI(s) in step 6 of FIG. 4.3.3.2-1 of 3GPP TS 23.502 V17.5.0, the H-SMF is responsible of later updating the QoS rules and QoS Flow level QoS parameters if needed for the QoS Flow(s) associated with the QoS rule(s) in the UE.

If the H-SMF initiated modification is to delete QoS Flows (e.g., triggered by PCF) which do not include QoS Flow associated with the default QoS rule and the V-SMF does not receive response from the UE, the V-SMF marks that the status of those QoS Flows is to be synchronized with the UE and send the list of such QoS Flow(s) to the H-SMF.

16-17. These steps are the same as steps 12-13 in clause 4.3.3.2 of 3GPP TS 23.502 V17.5.0 with the difference that the SMF is H-SMF.

In an embodiment, clause 4.23.4.2 of 3GPP TS 23.502 V17.5.0 may be amended as the following underline content.

4.23.4.2 UE Triggered Service Request without I-SMF Change/Removal

When both I-SMF and SMF are available for a PDU session and no I-SMF change or removal is needed during the service request procedure, the procedure in this clause is used. Compared to the procedure in clause 4.2.3.2 of 3GPP TS 23.502 V17.5.0, the SMF is replaced with the I-SMF and the impacted intermediate UPF(s) are UPFs that are controlled by I-SMF. Difference are captured below:
Steps 6a-6b, these steps are not needed as the CN Tunnel Info of UPF (PSA) allocated for N9 is available at the I-SMF when the I-SMF is inserted.
Step 7a, if a new intermediate UPF is selected, the I-SMF invokes Nsmf_PDUSession_Update Request (DN Tunnel Info of the new intermediate UPF. The I-SMF may also include UE location Information, Time Zone RAT type, Access Type and Operation Type set to “UP Activate”, if those information is changed and need to be notified to SMF. If DL Tunnel Info of new intermediate UPF is received, the SMF provides the DL Tunnel Info of new intermediate UPF received from I-SMF to UPF (PSA).
Step 10, this step does not apply as in this scenario the I-UPF is always needed.
Step 16, If the I-SMF needs to update SMF with e.g. change of UE location information, change of Time Zone, change of RAT type and/or change of Access type, the I-SMF invokes Nsmf_PDUSession_Update Request to send User Location Information, Time Zone, RAT type and/or Access Type to SMF. If the I-SMF invoked Nsmf_PDUSession_Update Request in step 7a with Operation Type “UP Activate”, the I-SMF also includes an Operation Type set to “UP Activated”.

If I-SMF has marked that status of one or more QoS Flows is to be synchronized with the UE, the I-SMF invokes Nsmf_PDUSession_Update Request including indication to synchronize the status of QoS Flow(s) with the UE.

If dynamic PCC is deployed and if Policy Control Request Trigger condition(s) have been met (e.g. change of Access Type, change of UE location), the SMF performs SMF initiated SM Policy Modification procedure as defined in clause 4.16.5.1 of 3GPP TS 23.502 V17.5.0 and may get the updated policy.
Steps 18a-18b, these steps do not apply as in this scenario the I-UPF is always needed.
Step 21a, this step does not apply as in this scenario the I-UPF is always needed.

In an embodiment, clause 4.23.4.3 of 3GPP TS 23.502 V17.5.0 may be amended as the following underline content.

4.23.4.3 UE Triggered Service Request with I-SMF Insertion/Change/Removal

When, as part of a UE Triggered Service Request, I-SMF is to be inserted, changed or removed, the procedure in this clause is used. It includes the following cases:
the UE moves from SMF service area to new I-SMF service area, a new I-SMF is inserted (i.e. I-SMF insertion); or
the UE moves from old I-SMF service area to new I-SMF service area, the I-SMF is changed (i.e. I-SMF change); or
the UE moves from old I-SMF service area to SMF service area, the old I-SMF is removed (i.e. I-SMF removal).

If the service request is triggered by network due to downlink data and a new I-UPF is selected, forwarding tunnel is established between the old I-UPF (if the old I-UPF is different from PSA) and the new I-UPF to forward buffered data.

For Home Routed Roaming case, the I-SMF (old and new) and I-UPF (old and new) are located in Visited PLMN, while the SMF and UPF (PSA) are located in the Home PLMN. In this HR roaming case only the case of I-SMF change applies (there is always a V-SMF for the PDU Session).

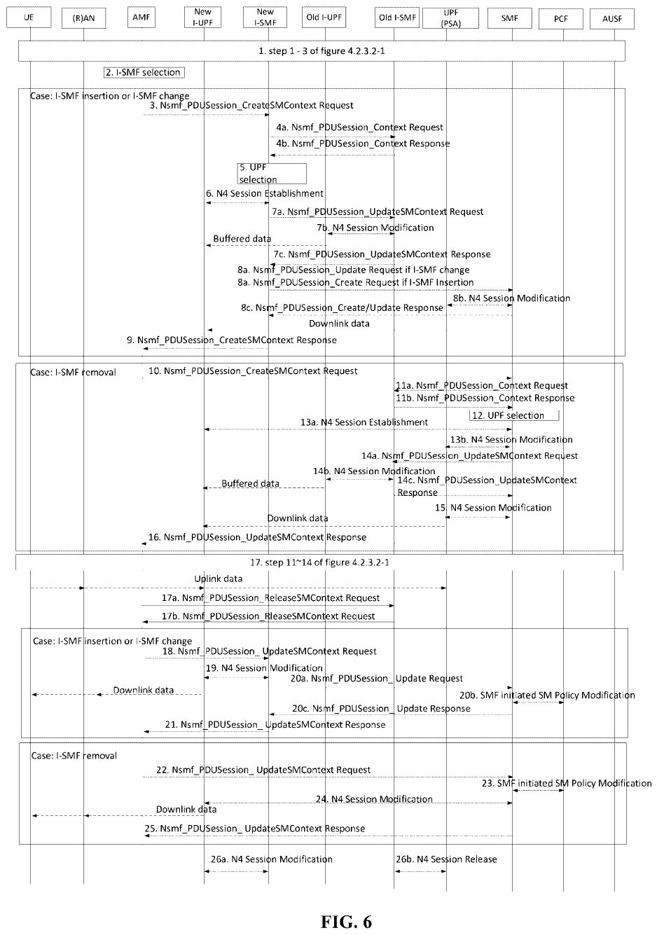

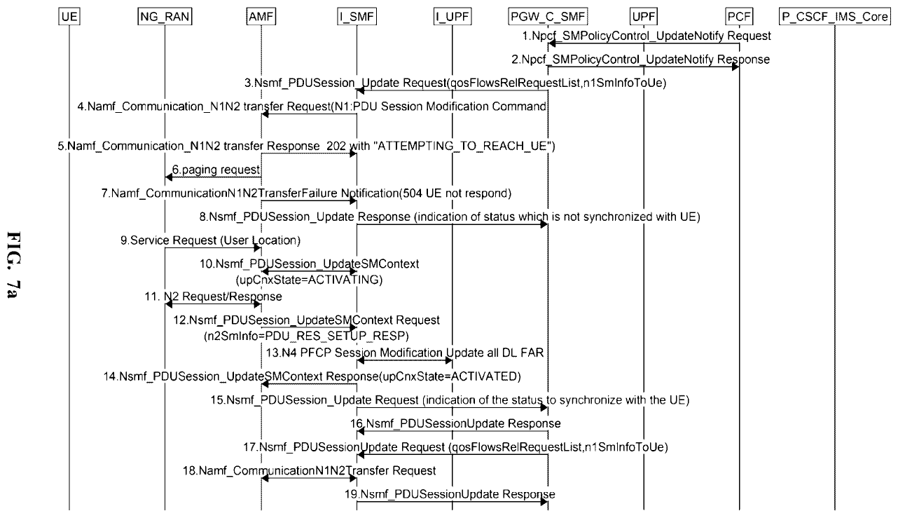

FIG. 6 shows a flowchart of UE Triggered Service Request procedure with I-SMF insertion/change/removal according to an embodiment of the present disclosure.

1. Same as the steps 1-3 defined clause 4.2.3.2 of 3GPP TS 23.502 V17.5.0.

2. The AMF determines whether new I-SMF needs to be selected based on UE location and service area of the SMF, if new I-SMF needs to be selected, the AMF selects a new I-SMF as described in clause 4.23.2 of 3GPP TS 23.502 V17.5.0.

Case: I-SMF insertion or I-SMF change, steps 3-9 are skipped for I-SMF removal case.

3. If the AMF has selected a new I-SMF, the AMF sends a Nsmf_PDUSession_CreateSMContext Request (PDU Session ID, SM Context ID, UE location info, Access Type, RAT Type, Operation Type) to the new I-SMF. The SM Context ID points to the old I-SMF in the case of I-SMF change or to SMF in the case of I-SMF insertion.

The AMF Set the Operation Type to “UP activate” to indicate establishment of N3 tunnel User Plane resources for the PDU Session(s). The AMF determines Access Type and RAT Type based on the Global RAN Node ID associated with the N2 interface.

If the UE Time Zone has changed compared to the last reported UE Time Zone then the AMF shall include the UE Time Zone IE in this message.

4a. The new I-SMF retrieves SM Context from the old I-SMF (in the case of I-SMF change) or SMF (in the case of I-SMF insertion) by invoking Nsmf_PDUSession_Context Request (SM context type, SM Context ID). The new I-SMF uses SM Context ID received from AMF for this service operation. SM Context ID is used by the recipient of Nsmf_PDUSession_Context Request in order to determine the targeted PDU Session. SM context type indicates that the requested information is all SM context, i.e. PDN Connection Context and 5G SM context.

4b. The old I-SMF in the case of I-SMF change or SMF in the case of I-SMF insertion responds with the SM context of the indicated PDU Session.

If there is Extended Buffering is applied and the Extended Buffering timer is still running in old-SMF or old I-UPF, or the service request is triggered by downlink data, the old I-SMF or SMF includes a forwarding indication in the response to indicate that a forwarding tunnel is needed for sending buffered downlink packets. For I-SMF insertion, if I-UPF controlled by SMF was available for the PDU Session, the SMF includes a forwarding indication.

5. The new I-SMF selects a new I-UPF: Based on the received SM context, e.g. S-NSSAI and UE location information, the new I-SMF selects a new I-UPF as described in clause 6.3.3 of 3GPP TS 23.501V17.5.0.

6. The new I-SMF initiates a N4 Session Establishment to the new I-UPF. The new I-UPF provide tunnel endpoints to the new I-SMF.

If forwarding indication was received, the new I-SMF also requests the new I-UPF to allocate tunnel endpoints to receive the buffered DL data from the old I-UPF and to indicate end marker reception on this tunnel via usage reporting. In this case, the new I-UPF begins to buffer the downlink packet(s) received from the UPF (PSA).

7a. If the tunnel endpoints for the buffered DL data were allocated, the new I-SMF invokes Nsmf_PDUSession_UpdateSMContext Request (tunnel endpoints for buffered DL data) to the old I-SMF in the case of I-SMF change in order to establish the forwarding tunnel. The new I-SMF uses the SM Context ID received from AMF for this service operation.

7b. The old I-SMF, in the case of I-SMF change initiates a N4 session modification to the old I-UPF to send the tunnel endpoints for buffered DL data to the old I-UPF. After this step, the old I-UPF starts to send buffered DL data to the new I-UPF.

If the old I-UPF receives end marker packets and there is no associated tunnel to forward these packets, the old I-UPF discards the received end marker packets and does not send any Data Notification to SMF.

7c. The old I-SMF, in the case of I-SMF change responds the new I-SMF with Nsmf_PDUSession_UpdateSMContext response.

8a. In the case of I-SMF change, the new I-SMF invokes Nsmf_PDUSession_Update Request (SM Context ID, new I-UPF DL tunnel information, SM Context ID at I-SMF, Access Type, RAT Type, DNAI list supported by the new I-SMF, Operation Type) towards the SMF. The new I-SMF uses the SM Context ID at SMF received from old I-SMF for this service operation.

In the case of I-SMF insertion, the new I-SMF invokes Nsmf_PDUSession_Create Request (new I-UPF DL tunnel information, new I-UPF tunnel endpoint for buffered DL data, SM Context ID at I-SMF, Access Type, RAT type, DNAI list supported by the new I-SMF, Operation Type) towards the SMF.

The SM Context ID at I-SMF is to be used by the SMF for further PDU Session operation, e.g. to notify the new I-SMF of PDU Session Release. If SM Context ID at the I-SMF exists (i.e. in the case of I-SMF change), the SMF shall replace the SM Context ID at I-SMF.

The new I-UPF tunnel endpoint for buffered DL data is used to establish the forwarding tunnel (from old I-UPF controlled by SMF to new I-UPF controlled by new I-SMF).

If the old I-UPF receives end marker packets and there is no associated tunnel to forward these packets, the old I-UPF discards the received end marker packets and does not send any Data Notification to SMF.

The Operation Type is set to “UP activate” to indicate that User Plane resource for the PDU Session is to be established.

8b. The SMF initiates N4 Session Modification toward the PDU Session Anchor UPF. During this step:
The SMF provides the new I-UPF DL tunnel information.
If different CN Tunnel Info need be used by PSA UPF, i.e. the CN Tunnel Info at the PSA for N3 and N9 are different, a CN Tunnel Info for the PDU Session Anchor UPF is allocated.
For I-SMF insertion, if a new I-UPF tunnel endpoint for buffered DL data is received, the SMF triggers the transfer of buffered DL data to the new I-UPF tunnel endpoint for buffered DL data.

If the DL tunnel information has changed, the SMF indicates the UPF (PSA) to send one or more “end marker” packets for each N9 tunnel to the old I-UPF immediately after switching the path to new I-UPF. From now on the PDU Session Anchor UPF begins to send the DL data to the new I-UPF as indicated in the new I-UPF DL tunnel information. The UPF (PSA) sends one or more “end marker” packets for each N9 tunnel to the old I-UPF immediately after switching the path to new I-UPF. If indicated by the new I-SMF in step 6, the new I-UPF reports to SMF when “end marker” has been received. The new SMF initiates N4 Session Modification procedure to indicate the new I-UPF to send the DL packet(s) received from the UPF (PSA).

8c. The SMF responds to the new I-SMF with Nsmf_PDUSession_Update Response (the DNAI(s) of interest for this PDU Session in the case of I-SMF change) or Nsmf_PDUSession_Create Response (the DNAI(s) of interest for this PDU Session, Tunnel Info at UPF (PSA) for UL data in the case of I-SMF insertion if it is allocated in step 8b).

In the case of I-SMF insertion and the PDU session corresponds to a LADN, the SMF shall release the PDU session after the service request procedure is completed.

In the case of I-SMF insertion the SMF starts a timer to release resource, i.e. resource for the indirect data forwarding tunnel.

In the case of I-SMF insertion and the CN Tunnel Info at PSA for N9 is received in the response, I-SMF provides the CN Tunnel Info at the PSA for N9 to I-UPF via N4 Session Modification Request.

9. The new I-SMF sends a Nsmf_PDUSession_CreateSMContext Response (N2 SM information (PDU Session ID, QFI(s), QoS profile(s), CN N3 Tunnel Info, S-NSSAI, User Plane Security Enforcement, UE Integrity Protection Maximum Data Rate), N1 SM Container, Cause)) to the AMF. The CN N3 Tunnel Info is the UL Tunnel Info of the new I-UPF.

If the PDU Session has been assigned any EPS bearer ID, the new I-SMF also includes the mapping between EPS bearer ID(s) and QFI(s) into the N2 SM information to be sent to the NG-RAN.

The new I-SMF starts a timer to release resource, i.e. resource for the indirect data forwarding tunnel.

Case: I-SMF removal: steps 10 to 16 are skipped for I-SMF insertion or I-SMF change cases.

10. If the UE has moved from service area of old I-SMF into the service area of SMF, the AMF sends a Nsmf_PDUSession_CreateSMContext Request (SUPI, PDU Session ID, AMF ID, SM Context ID at I-SMF, UE location info, Access Type, RAT Type) to the SMF.

If the UE Time Zone has changed compared to the last reported UE Time Zone then the AMF shall include the UE Time Zone IE in this message.

The AMF Set the Operation Type to “UP activate” to indicate establishment of User Plane resources for the PDU Session(s). The AMF determines Access Type and RAT Type based, as defined in clause 4.2.3.2 of 3GPP TS 23.502 V17.5.0.

11a. The SMF retrieves SM Context from the I-SMF by invoking Nsmf_PDUSession_Context Request (SM context type). The SMF uses SM Context ID received from AMF for this service operation. SM context type indicates that the requested SM context is all, i.e. PDN Connection Context and 5G SM context.

11b. The old I-SMF responds with the SM context of the indicated PDU Session. If there is Extended Buffering is applied and the Extended Buffering timer is still running in old-SMF or old I-UPF, or the service request is triggered by downlink data (i.e. the old I-SMF received downlink data notification from old I-UPF), the old I-SMF includes a forwarding indication in the response to indicate that a forwarding tunnel is needed for sending buffered downlink packets from old I-UPF to new I-UPF or PSA (in the case that new I-UPF is not selected).

12. The SMF may select a new I-UPF: If the SMF determines that the service area of the PSA does not cover the UE location, the SMF selects a new I-UPF based on S-NSSAI and UE location information as described in clause 6.3.3 of 3GPP TS 23.501 V17.5.0.

13. If a new I-UPF is selected by SMF, the SMF initiates a N4 Session Establishment to the new I-UPF. The new I-UPF provides tunnel endpoints to the SMF. If forwarding indication was received, the SMF requests the new I-UPF to allocate tunnel endpoints for forwarding data and to indicate end marker reception on this tunnel. In this case, the new I-UPF begins to buffer the downlink packet(s) received from the UPF (PSA).

If the new I-UPF is not selected, i.e. the PSA can serve the UE location, the SMF may initiate N4 Session Modification to the PSA to allocate UL N3 tunnel endpoints Info of PSA. The PSA provides the UL N3 tunnel endpoints to SMF. If the forwarding indication was received, the SMF requests the PSA to allocate the tunnel endpoints for the buffered DL data from the old I-UPF and indicate the PSA via usage reporting rule to report end marker to the SMF. In this case, the UPF (PSA) begins to buffer the DL data it may receive at the same time from the N6 interface. The UPF (PSA) sends one or more “end marker” packets according to the indication from SMF for each N9 tunnel to the old I-UPF immediately after switching the path to (R)AN. If indicated by the SMF, the UPF (PSA) reports to SMF when “end marker” packet is received. Then the SMF initiates N4 Session Modification procedure to indicate the UPF (PSA) to send the DL data received from the No interface.

14a. If the tunnel endpoints for the buffered DL data were allocated, the SMF invokes Nsmf_PDUSession_UpdateSMContext Request (tunnel endpoints for buffered DL data) to the old I-SMF in order to establish the forwarding tunnel. The SMF uses the SM Context ID received from AMF for this service operation.

14b. The old I-SMF initiates a N4 session modification to the old I-UPF and sends the tunnel endpoints for buffered DL data to the old I-UPF. After this step, the old I-UPF start to send buffered DL data to the new I-UPF or PSA if new I-UPF is not selected.

If the old I-UPF receives end marker packets and there is no associated tunnel to forward these packets, the old I-UPF discards the received end marker packets and does not send any Data Notification to SMF.

14c. The old I-SMF responds the SMF with Nsmf_PDUSession_UpdateSMContext response.

15. If a new I-UPF was selected by SMF, the SMF initiates N4 Session Modification toward the PDU Session Anchor UPF, providing the new I-UPF DL tunnel information. The PSA begins to send the DL data to the new I-UPF as indicated in the new I-UPF DL tunnel information. If the forwarding indication was received, the SMF indicates the PDU Session Anchor UPF to send one or more “end marker” packets. The UPF (PSA) sends one or more “end marker” packets according to the indication from SMF for each N9 tunnel to the old I-UPF immediately after switching the path to new I-UPF. If indicated by the SMF in step 13, the new I-UPF reports to SMF when “end marker” packet is received. The SMF initiates N4 Session Modification procedure to indicate the new I-UPF to send the DL packet(s) received from the UPF (PSA).

16. The SMF sends a Nsmf_PDUSession_CreateSMContext Response (N2 SM information (PDU Session ID, QFI(s), QoS profile(s), CN N3 Tunnel Info, S-NSSAI), N1 SM Container, Cause)) to the AMF. The CN N3 Tunnel Info is the UL Tunnel Info of the new I-UPF.

If the PDU Session has been assigned any EPS bearer ID, the SMF also includes the mapping between EPS bearer ID(s) and QFI(s) into the N2 SM information to be sent to the NG-RAN.

The SMF starts a timer to release the resource, i.e. resource for indirect data forwarding tunnel.

17. These steps are same as steps 12 to 14 in clause 4.2.3.2 of 3GPP TS 23.502 V17.5.0. After step 16, the Uplink data is transferred from (R)AN via new I-UPF (if exists) to PSA. If procedure in clause 4.2.3 of 3GPP TS 23.502 V17.5.0 is triggered together with this procedure, this step can be executed together with the corresponding steps in clause 4.2.3 of 3GPP TS 23.502 V17.5.0.

17a. If the step 9 or step 16 was successful response, in the case of I-SMF removal or change, the AMF sends Nsmf_PDUSession_ReleaseSMContext Request (I-SMF only indication) to old I-SMF for the release of resources in old I-SMF. The I-SMF only indication indicates to old I-SMF not to invoke resource release in SMF.

The old I-SMF starts a timer to release resources, i.e. resource for indirect data forwarding tunnel.

17b. The old I-SMF responds to AMF with Nsmf_PDUSession_ReleaseSMContext response.

Case: I-SMF insertion or I-SMF change: steps 18 to 21 are skipped for the I-SMF removal case.

18. The AMF sends an Nsmf_PDUSession_UpdateSMContext Request (N2 SM information, RAT type, Access type) to the new I-SMF.

If the AMF received N2 SM information (one or multiple) in step 17, then the AMF shall forward the N2 SM information to the relevant new I-SMF per PDU Session ID.

19. The new I-SMF updates the new I-UPF with the AN Tunnel Info and List of accepted QFI(s). Downlink data is now forwarded from new I-UPF to UE.

20a. The new I-SMF invokes Nsmf_PDUSession_Update request (RAT type, Access type, Operation Type) to SMF. The SMF updates associated access of the PDU Session.

The Operation Type is set to “UP activated” to indicate User Plane resource for the PDU Session has been established.

If I-SMF has marked that status of one or more QoS Flows is to be synchronized with the UE, the I-SMF include also an indication to synchronize the status of QoS Flow(s) with the UE.

20b. If dynamic PCC is deployed, SMF may initiate notification about new location information to the PCF (if subscribed) by performing an SMF initiated SM Policy Modification procedure as defined in clause 4.16.5.1 of 3GPP TS 23.502 V17.5.0. The PCF may provide updated policies. If the PCC rule(s) are updated, the SMF may initiate a N4 Session Modification procedure to UPF (PSA) based on the updated PCC rule(s).

20c. The SMF responds with Nsmf_PDUSession_Update Response.

21. The new I-SMF sends a Nsmf_PDUSession_UpdateSMContext Response to AMF.

Case: I-SMF removal: steps 22 to 25 are skipped for the I-SMF insertion or I-SMF change cases.

22. The AMF sends a Nsmf_PDUSession_UpdateSMContext Request (N2 SM information, RAT Type, Access Type) to the SMF. The AMF determines Access Type and RAT Type based on the Global RAN Node ID associated with the N2 interface.

If the AMF received N2 SM information (one or multiple) in step 17, then the AMF shall forward the N2 SM information to the relevant new I-SMF per PDU Session ID.

23. If dynamic PCC is deployed, SMF may initiate notification about new location information to the PCF by performing an SMF initiated SM Policy Modification procedure as defined in clause 4.16.5.1 of 3GPP TS 23.502 V17.5.0. The PCF may provide updated policies.

24. If a new I-UPF was selected by the SMF, the SMF updates the new I-UPF with the AN Tunnel Info and List of accepted QFI(s), otherwise, the SMF updates the PSA with the AN Tunnel Info and List of accepted QFI(s).

25. The SMF sends a Nsmf_PDUSession_UpdateSMContext Response to AMF.

26a. In the case of I-SMF insertion or I-SMF change, upon timer set in step 9 expires and the indirect data forwarding tunnel was established before, the new I-SMF sends N4 Session Modification request to new I-UPF to release resources for the forwarding tunnel.

In the case of I-SMF removal, upon timer set in step 16 expires and the indirect data forwarding tunnel was established before, the SMF sends N4 Session Modification request to the new I-UPF or PSA to release the resource for the forwarding tunnel.

26b. In the case of I-SMF removal or change, upon timer set in step 17a expires and the indirect data forwarding tunnel was established before, the old I-SMF sends N4 Session Release request to the old I-UPF to release resources for the PDU Session. The old I-SMF releases the SM Context for the PDU Session. If the old I-UPF acts as UL CL and is not co-located with local PSA, the old I-SMF also sends N4 Session Release request to the local PSA to release resources for the PDU Session.

In the case of I-SMF insertion, upon timer set in step 8c expires and the indirect data forwarding tunnel was established before, the SMF sends N4 Session Release request to the old I-UPF to release the resource for the PDU Session.

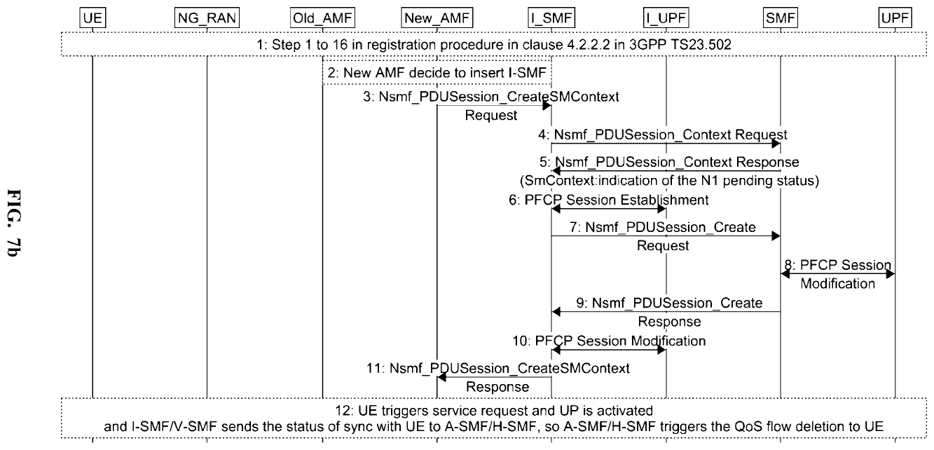

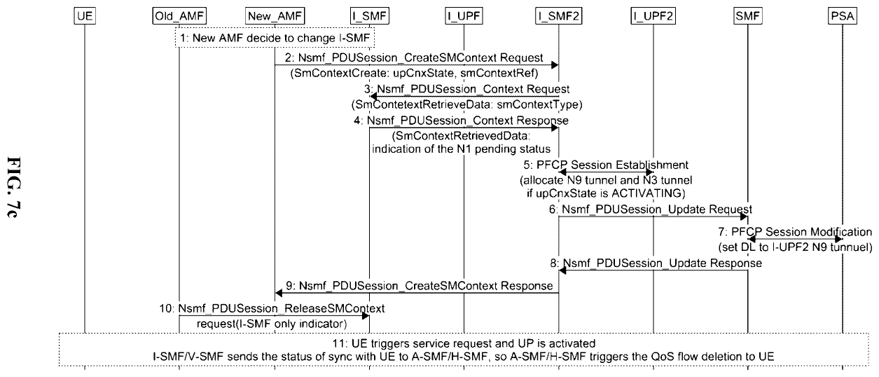

FIG. 7a shows a flowchart of network requested PDU Session Modification procedure according to an embodiment of the present disclosure.

Step 1. PCF sends Npcf_SMPolicyControl_UpdateNotify Request to PGW_C_SMF (packet data network gateway control plane (PGW_C) combined with SMF).

Step 2. PGW_C_SMF sends Npcf_SMPolicyControl_UpdateNotify Response to PCF;

Step 3. PGW_C_SMF sends Nsmf_PDUSession_Update Request(qosFlowsRelRequestList, n1SmInfoToUe) to I_SMF.

Step 4. I_SMF sends Namf_Communication_N1N2 transfer Request(N1: PDU Session Modification Command to AMF.

Step 5. AMF sends Namf_Communication_N1N2 transfer Response 202 with “ATTEMPTING_TO_REACH_UE”) to I_SMF.

Step 6. AMF sends a paging request to NG_RAN.

Step 7. AMF sends Namf_CommunicationN1N2TransferFailure Notification (504 UE not respond) to I_SMF.

Step 8. I_SMF sends Nsmf_PDUSession_Update Response comprising indication of status which is not synchronized with UE) to PGW_C_SMF.

I-SMF/V-SMF needs to mark that the UE is not synchronized for QoS flow deletion (not default QoS flow). N1 pending status which is used to inform A-SMF/H-SMF that UE is not reachable.

I-SMF/V-SMF sends the status indication to A-SMF/H-SMF that the QoS flow deletion is not synchronized with the UE due to UP inactive.

Step 9. NG_RAN sends Service Request (User Location) to AMF.

Step 10. AMF sends Nsmf_PDUSession_UpdateSMContext request (upCnxState=ACTIVATING) to I_SMF and receives Nsmf_PDUSession_UpdateSMContext response from I_SMF.

Step 11. AMF sends N2 Request to NG_RAN and receives N2 Response from NG_RAN.

Step 12. AMF sends Nsmf_PDUSession_UpdateSMContext Request (n2SmInfo=PDU_RES_SETUP_RESP) to I_SMF.

Step 13. I_SMF sends N4 PFCP (Packet Forwarding Control Protocol) Session Modification request to I_UPF to update all DL (downlink) FAR (forwarding action rules) and receive response from I_UPF.

Step 14. I_SMF sends Nsmf_PDUSession_UpdateSMContext Response(upCnxState=ACTIVATED) to AMF.

Step 15. I_SMF sends Nsmf_PDUSession_Update Request (indication of the status to synchronize with the UE) to PGW_C_SMF.

When I-SMF/V-SMF finds that UE can be reachable and there is a mark that QoS flows status is not synced with A-SMF/H-SMF, I-SMF/V-SMF sends the synchronized status (N1 pending status) to A-SMF/H-SMF.

Step 16. PGW_C_SMF sends Nsmf_PDUSessionUpdate Response to I_SMF.

Step 17. PGW C SMF sends Nsmf_PDUSessionUpdate Request (qosFlowsRelRequestList, n1SmInfoToUe) to I_SMF.

Step 18. I_SMF sends Namf_CommunicationN1N2Transfer Request to AMF.

Step 19. I_SMF sends Nsmf_PDUSessionUpdate Response to PGW_C_SMF.

Some messages of FIG. 7a may be same as the corresponding messages as described in various 3GPP specifications such as 3GPP TS 23.502 V17.5.0. Some messages (such as steps 8 and 15) of FIG. 7 are enhanced according to embodiments of the present disclosure.

FIG. 7b shows a flowchart of V-SMF/I-SMF insert procedure according to an embodiment of the present disclosure.

Step 1. Steps 1 to 16 in registration procedure as described in clause 4.2.2.2 in 3GPP TS 23.502 V17.5.0 are performed.

Step 2. New AMF decides to insert I-SMF.

Step 3. New_AMF sends Nsmf_PDUSession_CreateSMContext Request to I_SMF.

Step 4. I_SMF sends Nsmf_PDUSession_Context Request to SMF.

Step 5. SMF sendsNsmf_PDUSession_Context Response (SmContext: indication of the N1 pending status) to I_SMF.

For example, A-SMF/H-SMF can send this N1 pending status to new V-SMF/I-SMF to let new V-SMF/I-SMF know to send the UE synchronize status to A-SMF/H-SMF when UE is reachable.

Step 6. PFCP Session Establishment is performed between I_SMF and I_UPF.

Step 7. I_SMF sends Nsmf_PDUSession_Create Request to SMF.

Step 8. PFCP Session Modification is performed between SMF and UPF.

Step 9. SMF sends Nsmf_PDUSession_Create Response to I_SMF.

Step 10. PFCP Session Modification is performed between I_SMF and I_UPF.

Step 11. I_SMF sends Nsmf_PDUSession_CreateSMContext Response to New AMF.

Step 12. UE triggers service request and UP is activated. I-SMF/V-SMF sends the status of sync with UE to A-SMF/H-SMF, so A-SMF/H-SMF triggers the QoS flow deletion to UE.

Some messages of FIG. 7b may be same as the corresponding messages as described in various 3GPP specifications such as 3GPP TS 23.502 V17.5.0. Some messages (such as steps 5 and 12) of FIG. 7b are enhanced according to embodiments of the present disclosure.

FIG. 7c shows a flowchart of V-SMF/I-SMF change procedure according to an embodiment of the present disclosure.

Step 1. New AMF decides to change I-SMF.

Step 2. New AMF sends Nsmf_PDUSession_CreateSMContext Request(SmContextCreate: upCnxState, smContextRef) to I_SMF2.

Step 3. I_SMF2 sends Nsmf_PDUSession_Context Request(SmContetextRetrieveData: smContextType) to I_SMF.

Step 4. I_SMF sends Nsmf_PDUSession_Context Response (SmContextRetrievedData: indication of the N1 pending status to I_SMF2.

For example, old V-SMF/I-SMF sends the N1 pending status to new V-SMF/I-SMF.

Step 5. PFCP Session Establishment (allocate N9 tunnel and N3 tunnel if upCnxState is ACTIVATING) is performed between I_SMF2 and I_UPF2.

Step 6. I_SMF2 sends Nsmf_PDUSession_Update Request to SMF.

Step 7. PFCP Session Modification (set DL to I-UPF2 N9 tunnel) is performed between SMF and PSA.

Step 8. SMF sends Nsmf_PDUSession_Update Response to I_SMF2.

Step 9. I_SMF2 sends Nsmf_PDUSession_CreateSMContext Response to New AMF.

Step 10. Old_AMF sends Nsmf_PDUSession_ReleaseSMContext request (I-SMF only indicator) to I_SMF.

Step 11. UE triggers service request and UP is activated. I-SMF/V-SMF sends the status of sync with UE to A-SMF/H-SMF. So A-SMF/H-SMF triggers the QoS flow deletion to UE.

Some messages of FIG. 7c may be same as the corresponding messages as described in various 3GPP specifications such as 3GPP TS 23.502 V17.5.0. Some messages (such as steps 4 and 11) of FIG. 7c are enhanced according to embodiments of the present disclosure.

FIG. 7d shows a flowchart of PDU session modification procedure according to another embodiment of the present disclosure.

Step 1. AN release with GBR QoS flows but ngApCause is not “user inactivity” and “redirect”.

Step 2. I_SMF sends Nsmf_PDUSession_Update Request (HsmfUpdateData(NW_REQ_PDU_SES_MOD) to SMF.

For example, I-SMF decides to release this GBR QoS flow and sends “QoS flow is to be released” to A-SMF. New indication: N1 pending status.

Step 3. SMF sends Nsmf_PDUSession_Update Response (204 No content) to I_SMF.

A-SMF release the QoS flow without N16 interaction, so both A-SMF and I-SMF hold this QoS flow but send PCC rule inactive to PCF and send remove PDR to UPF.

Step 4. Npcf_PolicyControl_Update (PCC rule inactive) is performed between SMF and PCF.

Step 5. SMF sends PFCP Session Modification (remove DL (downlink) PDR (packet detection rules)) to UPF.

Step 6. UE triggers service request.

Step 7. I_SMF sends Nsmf_PDUSession_Update Request(indicate status to sync with UE) to SMF.

Step 8. SMF sends Nsmf_PDUSession_Update Response (204) to I_SMF.

Step 9. SMF sends Nsmf_PDUSession_Update Request(VsmfUpdateData) to I_SMF.

Step 10. Namf_communication_N1N2messagetransfer (N1: PDU Session Modification Command) is performed between AMF and I_SMF.

Step 11. AMF sends NGAP Request to NG_RAN.

Step 12. NAS between UE and NG_RAN.

Step 13. NG_RAN sends NGAP Response to AMF.

Step 14. AMF sends Nsmf_PDUSession_UpdateSMContext Request(N1 PDU Session Modification Complete) to I_SMF.

Step 15. PFCP Session Modification (Remove UL/DL PDR for the dedicated QoSs flows) is performed between I_SMF and I_UPF.

Step 16. I_SMF sends Nsmf_PDUSession_UpdateSMContext Response to AMF.

Step 17. I_SMF sends Nsmf_PDUSession_Update Response (VsmfUpdatedData) to SMF.

Step 18. PFCP Session Modification (Remove UL PDR for the dedicated QoS flows) is performed between SMF and UPF.

Some messages of FIG. 7d may be same as the corresponding messages as described in various 3GPP specifications such as 3GPP TS 23.502 V17.5.0. Some messages (such as steps 2 and 7) of FIG. 7d are enhanced according to embodiments of the present disclosure.

In an embodiment, during PDU Session Modification with V-SMF/I-SMF procedure, if the PDU Session Modification is to delete at least one QoS flow which do not include QoS Flow associated with the default QoS rule but UE is not reachable, the V-SMF/I-SMF sends status that the at least one QoS flow release cannot to be synchronized with the UE to H-SMF/A-SMF. H-SMF/A-SMF marks that the at least one QoS flow is not synchronized with UE.

In an embodiment, during AN-release procedure, if V-SMF/I-SMF decides to release at least one GBR QoS flow but UE is not reachable, V-SMF/I-SMF sends the status that the at least one GBR QoS flow release cannot to be synchronized with the UE to H-SMF/A-SMF. H-SMF/A-SMF marks that the at least one GBR QoS flow is not synchronized with UE.

In an embodiment, during Service Request procedure V-SMF/I-SMF procedure, if V-SMF/I-SMF has marked that status of one or more QoS Flows is to be synchronized with the UE, the V-SMF/I-SMF sends Nsmf_PDUSession_Update Request including indication to synchronize the status of QoS Flow(s) with the UE to H-SMF/A-SMF.

In an embodiment, during V-SMF/I-SMF insert/change, the new V-SMF/I-SMF can get the sync status from SMContext from H-SMF/A-SMF or old V-SMF/I-SMF. After UE is reachable, the new V-SMF/I-SMF can send the sync status to H-SMF/A-SMF.

Embodiments herein may provide many advantages, of which a non-exhaustive list of examples follows. In some embodiments herein, the status of at least one QoS flow can be synchronized with a terminal device when the at least one QoS flow is managed by the first SMF and the second SMF. In some embodiments herein, V-SMF/I-SMF can handle the use case that the QoS flow deletion is not synced with UE when deleting is triggered. The embodiments herein are not limited to the features and advantages mentioned above. A person skilled in the art will recognize additional features and advantages upon reading the following detailed description.

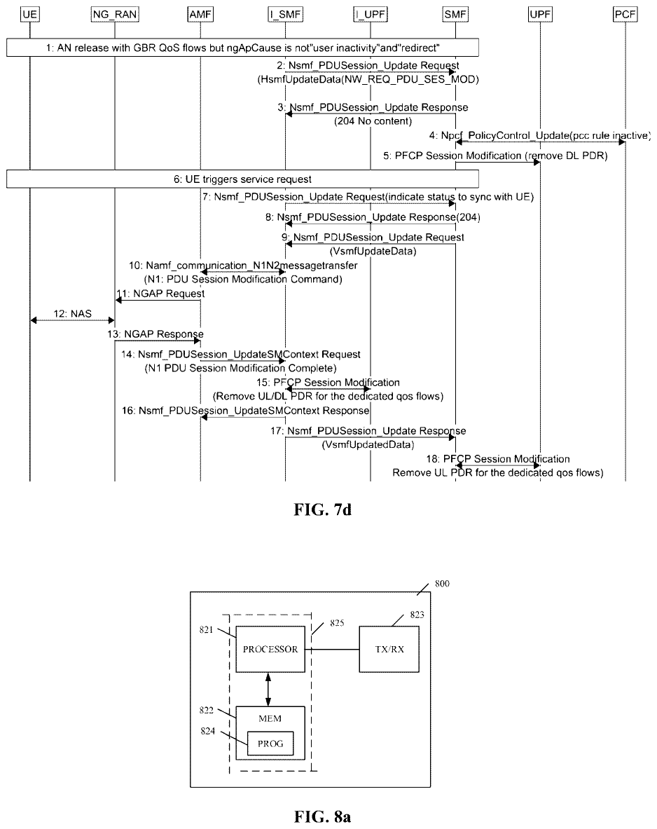

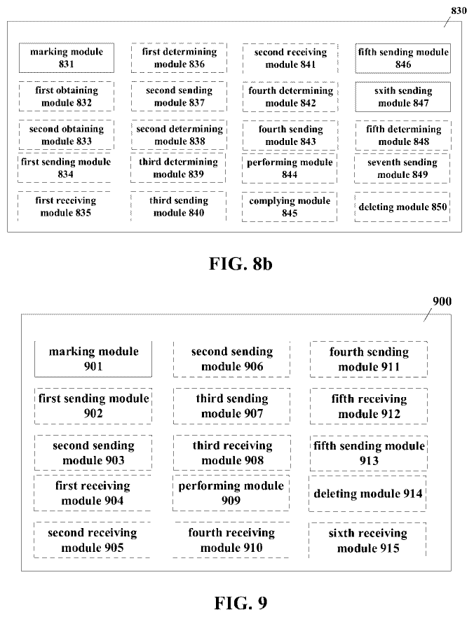

FIG. 8a is a block diagram showing an apparatus suitable for practicing some embodiments of the disclosure. For example, the first SMF, or the second SMF described above may be implemented as or through the apparatus 800.

The apparatus 800 comprises at least one processor 821, such as a digital processor (DP), and at least one memory (MEM) 822 coupled to the processor 821. The apparatus 800 may further comprise a transmitter TX and receiver RX 823 coupled to the processor 821. The MEM 822 stores a program (PROG) 824. The PROG 824 may include instructions that, when executed on the associated processor 821, enable the apparatus 800 to operate in accordance with the embodiments of the present disclosure. A combination of the at least one processor 821 and the at least one MEM 822 may form processing means 825 adapted to implement various embodiments of the present disclosure.

Various embodiments of the present disclosure may be implemented by computer program executable by one or more of the processor 821, software, firmware, hardware or in a combination thereof.

The MEM 822 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 821 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the first SMF, the memory 822 contains instructions executable by the processor 821, whereby the first SMF operates according to any of the methods related to the first SMF as described above.

In an embodiment where the apparatus is implemented as or at the second SMF, the memory 822 contains instructions executable by the processor 821, whereby the second SMF operates according to any of the methods related to the second SMF as described above.

FIG. 8b is a block diagram showing a first SMF according to an embodiment of the disclosure. As shown, the first SMF 830 comprises a marking module 831 configured to mark that a status of at least one quality of service (QoS) flow is to be synchronized with a terminal device. The at least one QoS flow is managed by the first SMF and a second SMF.

In an embodiment, the first SMF 830 further comprises a first obtaining module 832 configured to, during a first SMF insert procedure, obtain, from the second SMF, information that the status of the at least one QoS flow is to be synchronized with the terminal device and/or information used for the first SMF to send an N1 message to the terminal device to synchronize the status of the at least one QoS flow with the terminal device.

In an embodiment, the first SMF 830 further comprises a second obtaining module 833 configured to, during a first SMF change procedure, obtain, from an old first SMF, information that the status of the at least one QoS flow is to be synchronized with the terminal device and/or information used for the first SMF to send an N1 message to the terminal device to synchronize the status of the at least one QoS flow with the terminal device.

In an embodiment, the first SMF 830 further comprises a first sending module 834 configured to, during a first SMF change procedure, send, to a new first SMF, information that the status of the at least one QoS flow is to be synchronized with the terminal device and/or information used for the new SMF to send an N1 message to the terminal device to synchronize the status of the at least one QoS flow with the terminal device.

In an embodiment, the first SMF 830 further comprises a first receiving module 835 configured to receive a protocol data unit (PDU) session update request comprising a PDU session modification command for the at least one QoS flow from the second SMF.

In an embodiment, the first SMF 830 further comprises a first determining module 836 configured to determine that the terminal device is not reachable.

In an embodiment, the first SMF 830 further comprises a second sending module 837 configured to send a PDU session update response comprising information that the status of the at least one QoS flow is to be synchronized with the terminal device or is not synchronized with the terminal device to the second SMF.

In an embodiment, the first SMF 830 further comprises a second determining module 838 configured to determine a PDU session modification command for the at least one QoS flow.

In an embodiment, the first SMF 830 further comprises a third determining module 839 configured to determine that the terminal device is not reachable.

In an embodiment, the first SMF 830 further comprises a third sending module 840 configured to send a PDU session update request comprising information that the status of the at least one QoS flow is to be synchronized with the terminal device or is not synchronized with the terminal device to the second SMF.

In an embodiment, the first SMF 830 further comprises a second receiving module 841 configured to receive, from the second SMF, a PDU session update request comprising a PDU session modification command for the at least one QoS flow and information used for the first SMF to send an N1 message to the terminal device to synchronize the status of the at least one QoS flow with the terminal device.

In an embodiment, the first SMF 830 further comprises a fourth determining module 842 configured to determine that the terminal device is not reachable.

In an embodiment, the first SMF 830 further comprises a fourth sending module 843 configured to send information that the terminal device is not reachable to the second SMF.

In an embodiment, the first SMF 830 further comprises a performing module 844 configured to perform the PDU session modification command for the at least one QoS flow.

In an embodiment, the first SMF 830 further comprises a complying module 845 configured to, when the terminal device is reachable, comply the N1 message based on the information used for the first SMF to send an N1 message to the terminal device to synchronize the status of the at least one QoS flow with the terminal device.

In an embodiment, the first SMF 830 further comprises a fifth sending module 846 configured to send the N1 message to the terminal device.

In an embodiment, the first SMF 830 further comprises a sixth sending module 847 configured to send information that the status of the at least one QoS flow has been synchronized with the terminal device to the second SMF.

In an embodiment, the first SMF 830 further comprises a fifth determining module 848 configured to determine that the terminal device is reachable.

In an embodiment, the first SMF 830 further comprises a seventh sending module 849 configured to, when there is a mark that the status of the at least one QoS flow is to be synchronized with the terminal device, send a PDU session update request comprising information indicating the second SMF to synchronize the status of the at least one QoS flow with the terminal device to the second SMF.

In an embodiment, the first SMF 830 further comprises a deleting module 850 configured to, when the status of the at least one QoS flow has been synchronized with the terminal device, delete a mark that the status of the at least one QoS flow is to be synchronized with the terminal device.

FIG. 9 is a block diagram showing a second SMF according to an embodiment of the disclosure. As shown, the second SMF 900 comprises a marking module 901 configured to mark that a status of at least one quality of service (QoS) flow is to be synchronized with a terminal device. The at least one QoS flow is managed by a first SMF and the second SMF.

In an embodiment, the second SMF 900 further comprises a first sending module 902 configured to, during a first SMF insert procedure, send, to the first SMF, information that the status of the at least one QoS flow is to be synchronized with the terminal device and/or information used for the first SMF to send an N1 message to the terminal device to synchronize the status of the at least one QoS flow with the terminal device.

In an embodiment, the second SMF 900 further comprises a second sending module 903 configured to send a protocol data unit (PDU) session update request comprising a PDU session modification command for the at least one QoS flow to the first SMF.

In an embodiment, the second SMF 900 further comprises a first receiving module 904 configured to receive a PDU session update response comprising information that the status of the at least one QoS flow is to be synchronized with the terminal device or is not synchronized with the terminal device from the first SMF.

In an embodiment, the second SMF 900 further comprises a second receiving module 905 configured to receive a PDU session update request comprising information indicating the second SMF to synchronize the status of the at least one QoS flow with the terminal device from the first SMF.

In an embodiment, the second SMF 900 further comprises a second sending module 906 configured to send a PDU session update request comprising a PDU session modification command for the at least one QoS flow to the first SMF.

In an embodiment, the second SMF 900 further comprises a third sending module 907 configured to send, to the first SMF, a PDU session update request comprising a PDU session modification command for the at least one QoS flow and information used for the first SMF to send an N1 message to the terminal device to synchronize the status of the at least one QoS flow with the terminal device.

In an embodiment, the second SMF 900 further comprises a third receiving module 908 configured to receive information that the terminal device is not reachable from the first SMF.

In an embodiment, the second SMF 900 further comprises a performing module 909 configured to perform the PDU session modification command for the at least one QoS flow.

In an embodiment, the second SMF 900 further comprises a fourth receiving module 910 configured to, when the terminal device is reachable, receive information that the status of the at least one QoS flow has been synchronized with the terminal device to the second SMF.

In an embodiment, the second SMF 900 further comprises a fourth sending module 911 configured to send an event exposure subscribe request for a reachability event of the terminal device to an access and mobility management function (AMF).

In an embodiment, the second SMF 900 further comprises a fifth receiving module 912 configured to receive the reachability event of the terminal device from the AMF.

In an embodiment, the second SMF 900 further comprises a fifth sending module 913 configured to, when there is a mark that the status of the at least one QoS flow is to be synchronized with the terminal device, send a PDU session update request comprising a PDU session modification command for the at least one QoS flow to the first SMF.

In an embodiment, the second SMF 900 further comprises a deleting module 914 configured to, when the status of the at least one QoS flow has been synchronized with the terminal device, delete a mark that the status of the at least one QoS flow is to be synchronized with the terminal device.

In an embodiment, the second SMF 900 further comprises a sixth receiving module 915 configured to receive a PDU session update request comprising information that the status of the at least one QoS flow is to be synchronized with the terminal device or is not synchronized with the terminal device from the first SMF.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the first SMF or the second SMF may not need a fixed processor or memory, any computing resource and storage resource may be arranged from the first SMF or the second SMF in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method performed by a first session management function (SMF), comprising:
marking that a status of at least one quality of service (QoS) flow of a protocol data unit (PDU) session for a terminal device is to be synchronized with the terminal device, wherein the first SMF comprises at least one of: an intermediate SMF or a visited SMF.

2. (canceled)

3. The method according to claim 1, wherein the status of at least one QoS flow comprises a deletion of the at least one QoS flow.

4. The method according to claim 1, further comprising:
during a first SMF insert procedure, obtaining, from the second SMF, information that the status of the at least one QoS flow is to be synchronized with the terminal device and/or information used for the first SMF to send an N1 message to the terminal device to synchronize the status of the at least one QoS flow with the terminal device.

5. The method according to claim 1, further comprising:
during a first SMF change procedure, obtaining, from an old first SMF, information that the status of the at least one QoS flow is to be synchronized with the terminal device and/or information used for the first SMF to send an N1 message to the terminal device to synchronize the status of the at least one QoS flow with the terminal device; and/or
during the first SMF change procedure, sending, to a new first SMF, information that the status of the at least one QoS flow is to be synchronized with the terminal device and/or information used for the new SMF to send an N1 message to the terminal device to synchronize the status of the at least one QoS flow with the terminal device.

6. The method according to claim 1, further comprising:
receiving a protocol data unit (PDU) session update request comprising a PDU session modification command for the at least one QoS flow from the second SMF;
determining that the terminal device is not reachable; and
sending a PDU session update response comprising information that the status of the at least one QoS flow is to be synchronized with the terminal device or is not synchronized with the terminal device to the second SMF.

7. The method according to claim 1, further comprising:
determining a PDU session modification command for the at least one QoS flow;
determining that the terminal device is not reachable; and
sending a PDU session update request comprising information that the status of the at least one QoS flow is to be synchronized with the terminal device or is not synchronized with the terminal device to the second SMF.

8-9. (canceled)

10. The method according to claim 1, further comprising:
receiving, from the second SMF, a PDU session update request comprising a PDU session modification command for the at least one QoS flow and information used for the first SMF to send an N1 message to the terminal device to synchronize the status of the at least one QoS flow with the terminal device;
determining that the terminal device is not reachable;
sending information that the terminal device is not reachable to the second SMF;
performing the PDU session modification command for the at least one QoS flow;
when the terminal device is reachable, complying the N1 message based on the information used for the first SMF to send an N1 message to the terminal device to synchronize the status of the at least one QoS flow with the terminal device;
sending the N1 message to the terminal device; and
sending information that the status of the at least one QoS flow has been synchronized with the terminal device to the second SMF.

11. (canceled)

12. The method according to claim 1, further comprising:
determining that the terminal device is reachable; and
when there is a mark that the status of the at least one QoS flow is to be synchronized with the terminal device, sending a PDU session update request comprising information indicating the second SMF to synchronize the status of the at least one QoS flow with the terminal device to the second SMF.

13. The method according to claim 1, further comprising:
when the status of the at least one QoS flow has been synchronized with the terminal device, deleting a mark that the status of the at least one QoS flow is to be synchronized with the terminal device.

14-15. (canceled)

16. A method performed by a second session management function (SMF), comprising:
receiving, from a first SMF, information indicating user plane (UP) activation for a protocol data unit (PDU) session for a terminal device, or information indicating at least one quality of service (QoS) flow of the PDU session, wherein the at least one QoS flow's status is to be synchronized with the terminal device when a UP connection for the PDU session is activated;
wherein the first SMF comprises at least one of an intermediate SMF or a visited SMF and the second SMF comprises at least one of an SMF or a home SMF.

17. (canceled)

18. The method according to claim 16, wherein the status of at least one QoS follow comprises a deletion of at least one QoS flow.

19. The method according to claim 16, further comprising:
during a first SMF insert procedure, sending, to the first SMF, information that the status of the at least one QoS flow is to be synchronized with the terminal device and/or information used for the first SMF to send an N1 message to the terminal device to synchronize the status of the at least one QoS flow with the terminal device.

20. The method according to claim 16, further comprising:
sending a PDU session update request comprising a PDU session modification command for the at least one QoS flow to the first SMF, and
receiving a PDU session update response comprising information that the status of the at least one QoS flow is to be synchronized with the terminal device or is not synchronized with the terminal device from the first SMF;
or
receiving (432) a PDU session update request comprising information indicating the second SMF to synchronize the status of the at least one QoS flow with the terminal device from the first SMF, and
sending a PDU session update request comprising a PDU session modification command for the at least one QoS flow to the first SMF.

21. (canceled)

22. The method according to claim 16, further comprising:
sending, to the first SMF, a PDU session update request comprising a PDU session modification command for the at least one QoS flow and information used for the first SMF to send an N1 message to the terminal device to synchronize the status of the at least one QoS flow with the terminal device;
receiving information that the terminal device is not reachable from the first SMF;
performing the PDU session modification command for the at least one QoS flow; and
when the terminal device is reachable, receiving information that the status of the at least one QoS flow has been synchronized with the terminal device to the second SMF.

23. The method according to claim 16, further comprising:
sending an event exposure subscribe request for a reachability event of the terminal device to an access and mobility management function (AMF);
receiving the reachability event of the terminal device from the AMF; and
when there is a mark that the status of the at least one QoS flow is to be synchronized with the terminal device, sending a PDU session update request comprising a PDU session modification command for the at least one QoS flow to the first SMF.

24. (canceled)

25. The method according to claim 16, further comprising:
when the status of the at least one QoS flow has been synchronized with the terminal device, deleting a mark that the status of the at least one QoS flow is to be synchronized with the terminal device.

26. The method according to claim 16, further comprising:
receiving a PDU session update request comprising information that the status of the at least one QoS flow is to be synchronized with the terminal device or is not synchronized with the terminal device from the first SMF.

27-29. (canceled)

30. A first session management function (SMF), comprising:
a processor; and
a memory coupled to the processor, said memory containing instructions executable by said processor, whereby said first SMF is operative to:
mark that a status of at least one quality of service (QoS) flow of a protocol data unit (PDU) session for a terminal device is to be synchronized with the terminal device;
wherein the first SMF comprises at least one of: an intermediate SMF or a visited SMF.

31-35. (canceled)

36. The method according to claim 1, further comprising at least one of:
informing a second SMF of a user plane (UP) activation for the PDU session; and
informing the second SMF of the at least one QoS flow whose status is to be synchronized with the terminal device when a UP connection for the PDU session is activated;
wherein the second SMF comprises at least one of an SMF or a home SMF.

37. The method according to claim 16, before receiving, from a first SMF, information indicating user plane activation for a terminal device, or information indicating at least one QoS flow of a protocol data unit (PDU) session for the terminal device, further comprising:
marking that the status of the at least one QoS flow is to be synchronized with the terminal device.

38. The method according to claim 18, further comprising:
performing a PDU session modification procedure to remove the at least one QoS flow.
